(19) United States
(12) Patent Application Publication
(10) Pub. No.: US 2024/0193692 A1
(43) Pub. Date: Jun. 13, 2024

(54) HIGH PERFORMANCE DATA ANALYTICS SYSTEM FOR AUTOMATED INVESTMENT MANAGEMENT

(71) Applicant: Arun IYENGAR, Yorktown Heights, NY (US)

(72) Inventor: ARUN IYENGAR, YORKTOWN HEIGHTS, NY (US)

(21) Appl. No.: 18/077,798

(22) Filed: Dec. 8, 2022

(51) Int. Cl. G06Q 40/06

(52) U.S. Cl. CPC G06Q 40/06

(57) ABSTRACT

A high performance data analytics system with multiple processors for handling large data sets and large computational workloads. The multiple processors also provide high availability so one processor can take over for a failed processor. Advanced machine learning algorithms are used to glean insights from the data. An example system analyzes large data sets related to investments. Information can be streamed to the system from several external sources. The system continuously analyzes new data which is coming into the system using a variety of sophisticated machine learning techniques. Data analysis can be used to study different investments and identify investments which are likely to achieve high returns. The system can manage user accounts and automatically make investments for a large number of users.

### FIELD OF THE DISCLOSURE

The present invention generally relates to data analytics, distributed computing, and transaction processing systems and methods, and more particularly to an information processing system for automatically managing investments.

### BACKGROUND

Investing is a difficult task. There are a wide range of investments to choose from. Furthermore, the performances of the various investments can be difficult to understand and predict. There are a wide range of factors affecting investments. Human beings do not have the capacity to assimilate information on the thousands of different investment possibilities which are available, the past historical information on their prices, and the large number of factors which can affect the performance of investments in the future. Powerful computers along with advanced data analytics techniques are essential for analyzing a wide range of investment choices, understanding their past performance, and predicting their future performance. Developing the right algorithms enabling computers to properly analyze investments and make future investment choices is complicated and difficult. One of the problems is that financial market conditions are dynamic which can change many times even within a very short period of time, e.g., 1-2 days. A set of investments that worked well in the recent past might not perform as well going forward.

There is thus a need for better information processing systems and advanced data analysis algorithms which can analyze a wide variety of data to provide automated investment management.

### SUMMARY

Disclosed is a data analytics system for automatically managing investments. The system uses data analytics and machine learning techniques to make optimal decisions for managing investments. It has computational capabilities to analyze a large number of investments when data corresponding to the investments are rapidly changing. It is also scalable to manage accounts for several clients simultaneously.

The system can manage investments for a wide range of securities including but not limited to stocks, fixed income investments such as bonds, commodities, and volatility futures and options. The system incorporates analysis of large amounts of data containing patterns indicative of macroeconomic and market conditions to dynamically shift investments to the one or more securities most appropriate for the current macroeconomic and market conditions. The system can also make investment decisions according to user profiles associated with user accounts. The system has capabilities for managing individual bond investments based on when investors expect to need money. The system can select appropriate types of bonds for user accounts based on predefined user risk and investment parameters and on current macroeconomic and market conditions. The system can determine appropriate time periods and allocation amounts for investing in inflation-protected bonds. The system can trade risky securities with the potential for significant alpha in a manner which limits potential losses. The system also has features for managing investments in volatility futures and options.

### BRIEF DESCRIPTION OF THE SEVERAL VIEWS OF THE DRAWINGS

The accompanying figures can include the same reference numerals that refer to identical or functionally similar elements throughout the separate views. These figures, together with the specification, which contains the detailed description below, serve to illustrate various embodiments and to explain different principles and advantages and are all incorporated into the present disclosure, in which:

FIG. 1 is an illustrative example of components of an Intelligent Asset Allocator (IAA). Entities 11-18 can be configured to run on hardware depicted in FIG. 10. Entity 19 can be configured to run on a user's computer.

FIG. 2 is an illustrative example of a method used by an IAA to select at least one investment based on analysis of macroeconomic and market conditions.

FIG. 3 is an illustrative example of a method used by an Automated Bond Tracker (ABT) to manage fixed income securities.

FIG. 4 is an illustrative example of a method used by an Agile Investment Manager (AIM) which is appropriate for securities including those which could have high alpha and high beta.

FIG. 5 is an illustrative example of a method used by an IAA to trade volatility futures and options.

FIG. 6 is a graph illustrating an example of a decline in the iShares Core U.S. Aggregate Bond exchange-traded fund (ETF) (AGG) and the iShares 20+ Year Treasury Bond ETF (TLT) from Aug. 4, 2020 through Sep. 29, 2022.

FIG. 7 is a graph illustrating an example of a strong period for growth stocks. The ARK Genomic Revolution ETF (ARKG) and ARK Next Generation Internet ETF (ARKW) really soared. Since 2/12/2021, the performance of both of these funds has plummeted.

FIG. 8 is a graph illustrating an example of a strong period for value stocks. The funds are: Energy Select Sector SPDR Fund (XLE), Financial Select Sector SPDR Fund (XLF), Vanguard Value Index Fund (VTV), Vanguard Total Stock Market Index Fund (VTI), and Vanguard Value Index Fund (VTV).

FIG. 9 depicts examples of data analytics techniques and software libraries which can be used by an IAA. The software depicted in FIG. 9 can be configured to run on hardware depicted in FIG. 10.

FIG. 10 is a block diagram illustrating an example of a computer system which can be used by an IAA. The processors 102 can be communicatively coupled using at least one computer network. Software modules depicted in FIG. 1 and FIG. 9 can be configured to run on this hardware.

FIG. 11 is an operational flow diagram illustrating example computer system operations including computational and data management tasks which can be performed by an IAA.

### DETAILED DESCRIPTION

As required, this section discloses detailed embodiments; however, the disclosed embodiments are merely examples that illustrate systems and methods described below in various forms. Therefore, specific structural and functional details disclosed herein are only non-limiting examples provided as a basis for the claims and teaching one of ordinary skill in the art to variously employ the disclosed subject matter in virtually any appropriately detailed structure and function. Further, the terms and phrases used herein are not limiting but rather provide an understandable description.

### INTRODUCTION

Managing investments is a complicated task. In the past, it was largely done by humans making their own decisions. More recently, automated systems for making investments using software have become increasingly common. Such systems will often manage portfolios using approaches such as modern portfolio theory, with some enhancements and tweaks to this approach such as post modern portfolio theory and the Black-Litterman model.

An investment may comprise a security. A security is a financial asset or instrument that can be bought, sold, or traded. Examples of securities include stocks, bonds, certificates of deposit, mutual funds, exchange-traded funds, exchange-traded notes, options, futures, etc.

The Intelligent Asset Allocator (IAA) 10 can incorporate detailed information about different types of securities in different time periods to make better investment decisions. Securities exhibit different behaviors at different times. Buying and holding a fixed set of securities over an extended period of time without adjusting asset allocation based on macroeconomic and market conditions will not result in optimal performance.

The Intelligent Asset Allocator (IAA) 10 may use a scalable computer system with parallel processing to perform advanced data analytics to make optimal investment choices. Our system can analyze data on a large number of investments when data on the investments are rapidly changing. It can also manage investment accounts for several investors simultaneously.

Throughout this specification, we use several stock (ticker) symbols which refer to different stocks and funds. The table below lists the symbols and the definitions of those symbols. Please refer to this table to look up stock symbols which appear throughout the specification.

TABLE 1
Stock (ticker) symbols used throughout the specification. ETF stands
for exchange-traded fund. ETN stands for exchange-traded note.

| | |
|---|---|
| AA | Alcoa Corporation Stock |
| AGG | iShares Core U.S. Aggregate Bond ETF |
| ANGL | VanEck Fallen Angel High Yield Bond ETF |
| ARKG | ARK Genomic Revolution ETF |
| ARKW | ARK Next Generation Internet ETF |
| BAC | Bank of America Corporation Stock |
| BCIM | abrdn Bloomberg Industrial Metals Strategy |
| | K-1 Free ETF |
| BND | Vanguard Total Bond Market Index Fund |
| BNO | United States Brent Oil Fund, LP |
| BRK.B | Berkshire Hathaway Inc. Stock |
| C | Citigroup Inc. Stock |
| COP | ConocoPhillips |
| CORP | PIMCO Investment Grade Corporate Bond |
| | Index Exchange-Traded Fund |
| CVX | Chevron Corporation Stock |
| DBA | Invesco DB Agriculture Fund |
| DBB | Invesco DB Base Metals Fund |
| DHS | WisdomTree U.S. High Dividend Fund |
| DIG | ProShares Ultra Oil & Gas |
| DRXIX | DFA LTIP Portfolio Institutional Class |
| DWAS | Invesco DWA SmallCap Momentum ETF |
| EDV | Vanguard Extended Duration Treasury Index |
| | Fund |
| ERX | Direxion Daily Energy Bull 2X Shares |
| FALN | iShares Fallen Angels USD Bond ETF |
| FDL | First Trust Morningstar Dividend Leaders |
| | Index Fund (FDL) |
| FDVLX | Fidelity Value Fund |
| FLSA | Franklin FTSE Saudi Arabia ETF |
| FMHI | First Trust Municipal High Income ETF |
| FTEC | Fidelity MSCI Information Technology Index |
| | Fund |
| FXU | First Trust Utilities AlphaDEX Fund |
| FYC | First Trust Small Cap Growth AlphaDEX Fund |
| GSG | iShares S&P GSCI Commodity-Indexed Trust |
| GUSH | Direxion Daily S&P Oil & Gas Exp. & Prod. Bull |
| | 2X Shares |
| HDV | iShares Core High Dividend ETF |
| IBUY | Amplify Online Retail ETF |
| IEO | iShares U.S. Oil & Gas Exploration & |
| | Production ETF |
| IYH | iShares U.S. Healthcare ETF |
| IYK | iShares US Consumer Staples ETF |
| IYW | iShares U.S. Technology ETF |
| JPM | JPMorgan Chase & Co. Stock |
| KBWB | Invesco KBW Bank ETF |
| KRE | SPDR S&P Regional Banking ETF |
| KSA | iShares MSCI Saudi Arabia ETF |
| LQD | iShares iBoxx $ Investment Grade Corporate |
| | Bond ETF |
| LTPZ | PIMCO 15+ Year U.S. TIPS Index Exchange- |
| | Traded Fund |
| LVHI | Franklin International Low Volatility High |
| | Dividend Index ETF |
| MAYHX | BlackRock High Yield Municipal Fund |
| | Institutional Shares |
| MTBIX | MainStay Mackay Tax Free Bond Fund Class I |
| NRGU | MicroSectors U.S. Big Oil Index 3X Leveraged |
| | ETNs |
| ONLN | ProShares Online Retail ETF |
| PDBC | Invesco Optimum Yield Diversified |
| | Commodity Strategy No K-1 ETF |
| PPH | VanEck Pharmaceutical ETF |
| PXE | Invesco Dynamic Energy Exploration & |
| | Production ETF |
| QQQ | Invesco QQQ Trust |
| QQQM | Invesco NASDAQ 100 ETF |
| RHS | Invesco S&P 500 Equal Weight Consumer |
| | Staples ETF |
| RPV | Invesco S&P 500 Pure Value ETF |
| RWJ | Invesco S&P SmallCap 600 Revenue ETF |
| RWK | Invesco S&P MidCap 400 Revenue ETF |
| SHY | iShares 1-3 Year Treasury Bond ETF |
| SLYV | SPDR S&P 600 Small Cap Value ETF |
| SMH | VanEck Semiconductor ETF |
| SOXL | Direxion Daily Semiconductor Bull 3X Shares |
| SOXX | iShares Semiconductor ETF |
| SPIP | SPDR Portfolio TIPS ETF |
| SPVU | Invesco S&P 500 Enhanced Value ETF |
| SPXL | Direxion Daily S&P 500 Bull 3X Shares |
| SPY | SPDR S&P 500 ETF Trust |
| TAGS | Teucrium Agricultural Fund |
| TECL | Direxion Daily Technology Bull 3X Shares |
| TIP | iShares TIPS Bond ETF |
| TLT | iShares 20+ Year Treasury Bond ETF |
| TQQQ | ProShares UltraPro QQQ |
| UGA | United States Gasoline Fund, LP |
| UPRO | ProShares UltraPro S&P500 |
| USL | United States 12 Month Oil Fund, LP |
| USMV | iShares MSCI USA Min Vol Factor ETF |
| USO | United States Oil Fund, LP |
| UVIX | 2x Long VIX Futures ETF |
| VBTLX | Vanguard Total Bond Market Index Fund |
| | Admiral Shares |
| VCLT | Vanguard Long-Term Corporate Bond Index |
| | Fund |
| VGIT | Vanguard Intermediate-Term Treasury Index |
| | Fund |
| VGLT | Vanguard Long-Term Treasury Index Fund |
| VGSH | Vanguard Short-Term Treasury Index Fund |
| VGT | Vanguard Information Technology Index |
| | Fund |
| VIXM | ProShares VIX Mid-Term Futures ETF |
| VIXY | ProShares VIX Short-Term Futures ETF |
| VLUE | iShares MSCI USA Value Factor ETF |
| VOO | Vanguard 500 Index Fund |
| VOT | Vanguard Mid-Cap Growth Index Fund |
| VTC | Vanguard Total Corporate Bond ETF |
| VTEB | Vanguard Tax-Exempt Bond Index Fund |
| VTI | Vanguard Total Stock Market Index Fund |
| VTIP | Vanguard Short-Term Inflation-Protected |
| | Securities Index Fund |
| VTV | Vanguard Value Index Fund |
| VUG | Vanguard Growth Index Fund |
| VXX | iPath Series B S&P 500 VIX Short-Term |
| | Futures ETN |
| VXZ | iPath Series B S&P 500 VIX Mid-Term Futures |
| | ETN |
| WFC | Wells Fargo & Company stock |
| XBI | SPDR S&P Biotech ETF |
| XBM.TO | iShares S&P/TSX Global Base Metals Index |
| | ETF |
| XLE | Energy Select Sector SPDR Fund |
| XLF | Financial Select Sector SPDR Fund |
| XLK | Technology Select Sector SPDR Fund |
| XLP | Consumer Staples Select Sector SPDR Fund |
| XLU | Utilities Select Sector SPDR Fund |
| XLV | Health Care Select Sector SPDR Fund |
| XME | SPDR S&P Metals and Mining ETF |
| XOM | Exxon Mobil Corporation Stock |
| XSD | SPDR S&P Semiconductor ETF |
| XSVM | Invesco S&P SmallCap Value with Momentum |
| | ETF |
| ZROZ | PIMCO 25+ Year Zero Coupon U.S. Treasury |
| | Index Exchange-Traded Fund |

Throughout this specification, when we refer to the stock market declining or increasing, we are referring to a stock market index such as the S&P 500 increasing or decreasing.

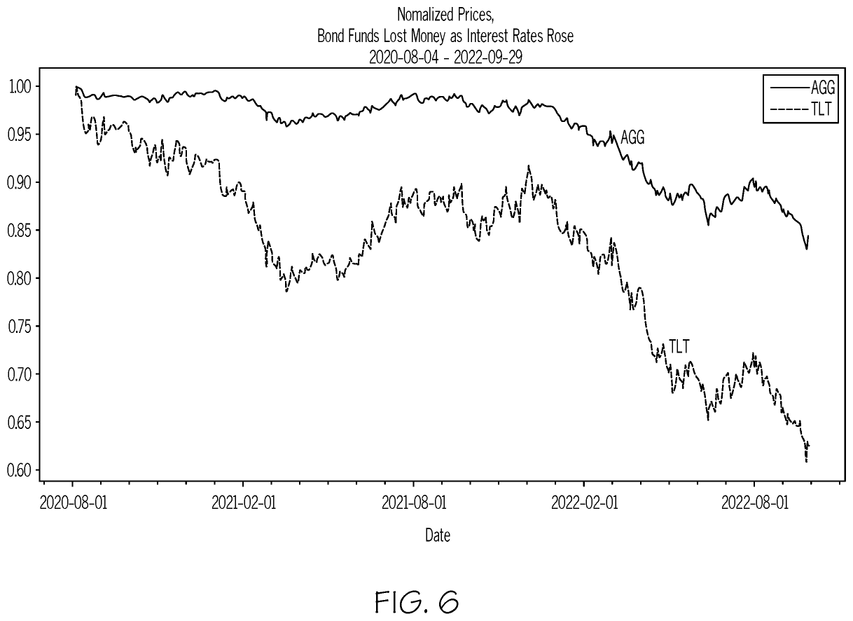

As an example of how it is useful to consider characteristics of specific time periods when choosing to make investments, bond funds can underperform when interest rates rise. From Aug. 4, 2020-Jun. 14, 2022, the iShares Core U.S. Aggregate Bond ETF (AGG) fell 14.4% (with more losses later in 2022), the worst drawdown in its history (FIG. 6). On Aug. 4, 2020, interest rates were at historically low levels. The Federal Funds rate was close to 0, and the Federal Reserve (the Federal Reserve is the central bank of the United States of America) was further suppressing interest rates via its bond purchases. It was clear at that time that there was little upside to bonds, as interest rates were likely to rise. The macro-economic conditions suggested at that time that having a reduced allocation to bond funds was prudent.

Most of the losses to bond funds such as AGG happened after the Federal Reserve started reducing the extraordinary amount of support they had been providing to support financial markets after Covid caused the financial markets to crash in February and March 2020. Around Nov. 3, 2021, the Federal Reserve announced that they would begin tapering bond purchases. This was a clear indication that bond funds could see further declines in the near future.

On Nov. 30, 2021, Federal Reserve Chair Jerome Powell testified to the Senate Banking Committee that inflation was considerably more persistent than he and other FOMC members had previously thought was the case. One consequence was speeding up the tapering of bond purchases to bring the current round of quantitative easing to a conclusion more quickly. This was a clear indication that further weakness could be in store for bond markets in the near future.

As 2022 unfolded, it became increasingly clear that inflation was a significant problem (it should be noted that there were warning signs of high inflation going back to at least early 2021; The Federal Reserve was slow to realize how serious the problem was) and that the Federal Reserve was committed to raising interest rates significantly to try to bring inflation under control. This would clearly have a negative effect on bond valuations.

There were several clear warning signs that bond funds were at risk of significant losses from macroeconomic conditions. While the best time to exit bond funds such as AGG was arguably around 8/4/2020, significant losses could still have been avoided by waiting until the Federal Reserve adopted its hawkish stance to fight inflation. There were several indications of this starting with Jerome Powell's testimony to the Senate Banking Committee on Nov. 30, 2021.

Asset allocation based on macroeconomic and market conditions (AAMM) is an investment strategy which makes use of macroeconomic information to reduce allocations to bond funds when conditions such as those described above indicate that interest rates could rise significantly in the near future and reduce bond valuations.

In order to manage investments precisely and scale to a large number of investors, AAMM is implemented in software. AAMM can be implemented as part of a robo-advisor. A number of companies provide robo-advisors including Betterment, Wealthfront, SoFi, Ellevest, Fidelity, Vanguard, and others.

AAMM can also be implemented in software that institutional investors or hedge funds use to make investments. Several on-line brokerage systems from companies such as Interactive Brokers provide application programming interfaces (APIs) (e.g. Interactive Brokers provides a Python API) which computer programs can use to trade financial securities. A person with sufficient software skills could implement AAMM in software and manage portfolios of investments; securities could be directly traded by using the appropriate API (s) to communicate with a brokerage system such as the one from Interactive Brokers. E*Trade, IG, and TD Ameritrade are examples of other brokerage systems which provide APIs for trading financial securities.

Performance for a security can be a return on investment for the security. Performance can also be risk-adjusted to give at least some preference to less volatile securities and/or securities with lower drawdowns. Performance of a security can be absolute. Performance can also be relative; for example, performance of a security can be calculated relative to a market index, such as the S&P 500. Performance can be a total return on investment. Performance can also be a rate of return; for example, performance can be expressed as a compound annual growth rate for a value of a security.

The computerized system implementing AAMM is the Intelligent Asset Allocator (IAA) 10. The IAA 10 has a number of advantages over a human investor. The IAA can analyze significantly more data in a short period of time. There are thousands of possible securities to invest in, and no human can properly analyze and keep track of the performances of all of them. Furthermore, the IAA can continuously monitor these securities for price changes and make trades quickly in response to these price changes. Human beings don't have the capability to monitor a large number of securities over time for continuous price changes and correctly make trades immediately in response to the price changes.

Furthermore, there are many past intervals where it is advantageous to analyze investment performance. The IAA can identify all of these past intervals and quickly analyze performance across a broad range of securities.

The market data and economic data the IAA analyzes spans decades. The analysis of such data requires computers, as humans don't have the capability to do such analysis.

The IAA can make financial trades at very specific times in response to evolving market conditions. Human beings do not have the ability to analyze the data this quickly and make financial trades in such a precise fashion.

The scalability of the IAA is another advantage. The IAA 10 can manage portfolios for many investors and make timely financial trades based on current market conditions. A human being would not be able to analyze data and respond quickly enough to manage even a single account as accurately as the IAA can manage many accounts.

It should also be noted that the IAA can make objective investment decisions. Human beings can make mistakes and errors of judgements.

The IAA can also work in conjunction with at least one human expert to make even better investment choices. For example, a human expert can provide input on macroeconomic conditions which the IAA might have trouble inferring from its data sources.

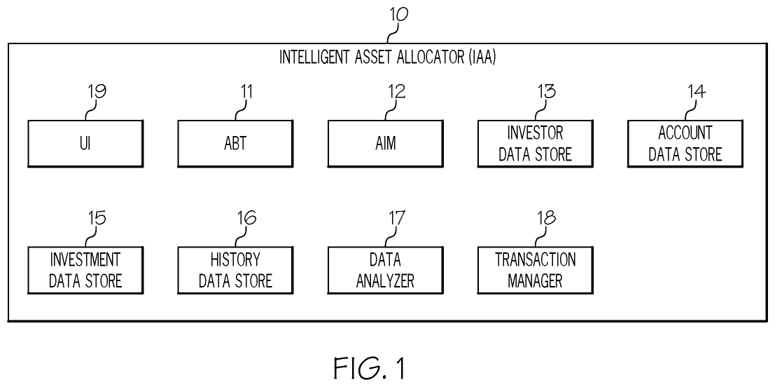

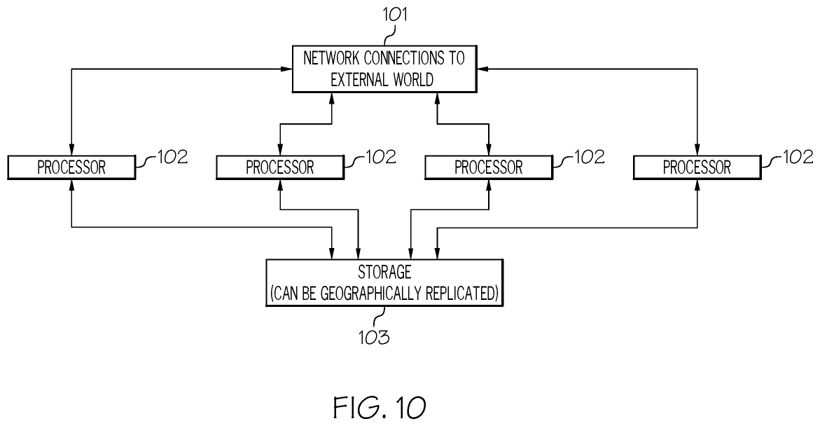

FIG. 1 shows example features of the IAA 10. Entities 11-18 can be configured to run on hardware depicted in FIG. 10. Entity 19 can be configured to run on a user's computer, wherein the user could be an investor.

The IAA has a user interface (UI), 19, which users use to communicate with the IAA. The UI is flexible and can run on several different types of computers. For example, the UI could be Web-based and accessible on a standard Web browser. The UI could also run as a mobile application (app) on a mobile device, such as a phone, tablet computer, watch, etc. The UI could also run as an application program on a computer.

The Automated Bond Tracker (ABT) 11 manages fixed income security investments for users and is described in detail below.

The Agile Investment Manager (AIM) 12 can effectively manage securities which have the potential for high returns on investment but are volatile and can also lose money. The AIM is described in detail below.

The term return, or return on investment, is commonly used. A return is a monetary gain of an investment relative to its cost. One method for calculating return on investment is to divide the profit from the investment by the cost of the investment.

The investor data store 13 manages information for investors, such as their names, ages, contact information, social security numbers/tax IDs, investor preferences (e.g. types of investments they are interested in, how soon they intend to access money in their portfolios, risk levels, etc.).

This data store contains information which is highly confidential. It should thus be maintained in a data store with proper security to prevent it from being accessed by untrusted parties. Strong encryption can be used for confidential information.

An IAA data store can be implemented using at least one relational database management system (RDBMS), such as Microsoft SQL Server, Oracle, IBM DB2, MySQL, etc.

An IAA data store can also be implemented using at least one NoSQL store such as MongoDB, CouchDB, Cassandra, HBase, etc.

It is possible to use at least one cloud database, such as at least one offered by Amazon Web Services, Microsoft Azure, and other cloud providers. It should be noted that a cloud database can present a security risk. Therefore, it may not always be appropriate to use cloud databases for highly confidential information. While encryption can mitigate some of the risks, the overall security and confidentiality of the data management system need to be properly architected.

The account data store 14 manages account information for investment accounts, such as the account owner, account identification number, type of investment account, investments held in the account and amount of each investment, preferences associated with the account, and other information. Investors may have multiple accounts. Account information may be highly confidential. Proper security and encryption are thus useful for managing the account data store 14.

The investment data store 15 manages information about several of the investments that are commonly used. For example, there are a variety of consumer staples ETFs that the IAA uses, such as XLP, RHY, IYK, and others. Information about these ETFs, their past performance, and circumstances under which they are most appropriate could be contained in the investment data store 15.

The history data store 16 manages information about past history of the markets, as well as past economic data. This would include information such as past performance of stocks, bonds, funds, market indices; past information on interest rates, inflation rates, employment data, GDP, and a variety of other past macroeconomic and market data; other information, such as past commodity prices, etc.

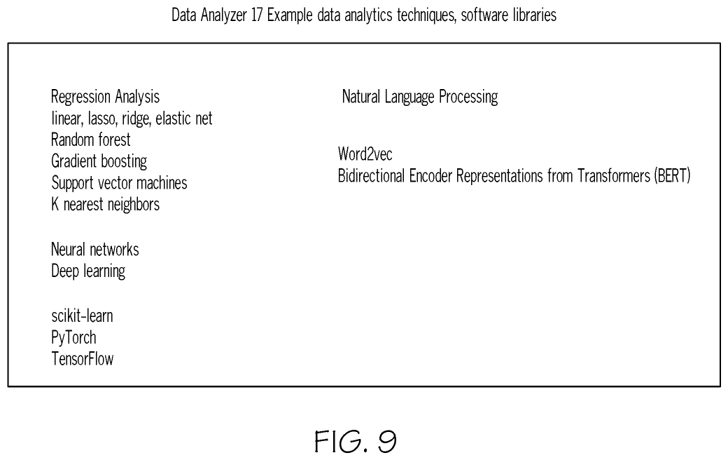

The data analyzer 17 analyzes information in order to determine what financial trades to make, as well as what recommendations to make. It can use the investment data store 15 as well as the history data store 16. The data analyzer can also obtain data from other sources on market and economic information. The other sources the data analyzer 17 can use include Yahoo! Finance, the US government, Quandl, Factset, Bloomberg, Trading Economics, and others. Some of the data analytics and machine learning techniques implemented by the data analyzer 17 are depicted in FIG. 9. The data analyzer 17 implements other data analysis techniques as well. The data analyzer software can be configured to run on the example computing hardware depicted in FIG. 10.

The data analyzer 17 is scalable to handle significant computational loads. It is analyzing many investments, and the data on the investments may be changing rapidly. Price data is one example of rapidly changing data. The data analyzer 17 is capable of continuously analyzing thousands of investments (financial securities, including stocks, bonds, stock funds, bond funds, commodity funds, volatility funds, and other types of securities) wherein there may be multiple price changes per second. The IAA can analyze data, including price changes, which change thousands of times per second. In response to price changes, the transaction manager 18 can quickly make trades.

In order to scale to handle high computational loads, the IAA 10 can be scaled to multiple processors 102 (see FIG. 10), each with multiple cores. The multiple processors 102 also provide high availability. If one processor fails, then another processor can take over computations from the failed processor. The example software modules shown in FIGS. 1 and 9 can be configured to run on the example computing hardware shown in FIG. 10.

FIG. 10 shows that the storage 103 can be geographically replicated. This can be used for preserving information if something happens to the primary site.

FIG. 10 also shows that the computers have external network connections to the external world 101. These external network connections can allow the data analyzer to obtain data from external sources, as described above. They can also allow the transaction manager 18 to make financial trades.

The transaction manager 18 executes financial trades (e.g. buying and selling stocks, bonds, CDs, funds, etc.) and logs the results in the account data store 14. The transaction manager can use an API to trade securities, such as the ones offered by Interactive Brokers. E*Trade, IG, and TD Ameritrade and others. In this case, Interactive Brokers. E*Trade, IG, and TD Ameritrade, etc. would actually perform the trades.

Alternatively, a company with the capability to directly trade financial securities could implement an IAA and integrate it directly with their trading platform. In that case, the transaction manager could actually be making the stock trades.

In either case, the transaction manager can keep records of financial trades which occur as part of account information within the account data store 14 (as well as other data stores) and can handle failures.

The IAA buys and sells securities by executing at least one transaction through the transaction manager 18. The transaction manager 18 persistently records the results of transactions in data stores including the account data store 14. Failed transactions can be retried up to a maximum number of retries.

Since the IAA can manage accounts for a large number of customers, the transaction manager 18 is capable of executing thousands of trades per second on behalf of these customers. Multiple processors can be used (FIG. 10) both for scaling the transaction manager 18 to handle high transaction rates and for high availability, wherein one processor can take over computations for a failed processor.

The IAA manages information about investors as well as investments. The IAA 10 can ask investors a series of questions to gauge both their investment preferences and risk tolerance levels. The investors can provide input to the IAA via the UI 19. The IAA uses investment preferences and risk tolerance levels determined from investor input to make investment choices for investors. The IAA can assign a high risk tolerance level or a low risk tolerance level to investors based on input provided by the investors.

The IAA can also assign numerical risk tolerance scores to investors based on their inputs; these risk tolerance scores are positively correlated with their risk tolerance levels. Using this approach, a risk tolerance score above a first threshold could indicate a high risk tolerance level. A risk tolerance score below a second threshold could indicate a low risk tolerance level. Risk tolerance scores between the first and second threshold would indicate a moderate risk tolerance level.

Risk tolerance levels can be categorical. For example, the IAA can classify a risk tolerance level as being one of high, moderate, and low. The number of risk tolerance levels can be more than 3.

The IAA can buy and sell financial securities. It can also make recommendations for buying and selling financial securities. A human being can take the recommendations provided by the IAA in order to buy and sell financial securities.

The IAA considers market conditions, in addition to macroeconomic conditions. Among other things, this means that it can consider recent prices and price trends in securities to make the best investment decisions.

We now give detailed examples of how the IAA 10 can analyze data and make good investment choices.

For example, if interest rates (for example, interest rates for one or more US treasury bonds) are rising, this can be good for financial stocks, such as bank stocks. This might suggest that financial stocks are a good investment at the current time. Examples of financial stocks include BRK.B, JPM, BAC, WFC, C (symbols used throughout this specification are defined in Table 1), and others. The IAA can monitor recent trends in financial stocks to see if the stocks are sufficiently outperforming market indices. If so, the IAA can invest a higher proportion of money in financial stocks than it otherwise would. If not, then the IAA may refrain from investing a higher portion of money in financial stocks than it otherwise would.

Analysis of recent prices complements the macroeconomic analysis. Just because certain macroeconomic conditions such as rising interest rates are occurring does not necessarily mean that stocks in question will exhibit expected behavior, such as bank stocks outperforming the S&P 500 when interest rates are rising. Similarly, if a particular security is beating the overall market and there is no clear macroeconomic explanation as to why this is occurring, it can be risky to invest a significant amount of money in the security as the trend might not continue. However, when a security is performing well and there are clear macroeconomic reasons for the outperformance, there may be a good chance of that security continuing to outperform the overall market while the macroeconomic conditions continue to be favorable and the security does not become overvalued.

The IAA can invest in individual stocks, as well as funds, such as mutual funds and exchange-traded funds (ETFs), as well as exchange-traded notes (ETNs). For example, XLF is a financial sector ETF the IAA can invest in, while KBWB and KRE are bank ETFs the IAA can invest in. A stock sector, or stock market sector, is a set of stocks that are grouped together because the companies corresponding to the stocks are in similar industries. The IAA can monitor the performance of funds to assess market conditions. For example, to assess performance of bank stocks, the IAA can examine the performance of funds such as KBWB and KRE, in addition to looking at the performance of individual bank stocks. The performance of a well-constructed fund devoted to a sector, industry, and/or index can provide considerable insight into the performance of the sector, industry, and/or index that the fund is concentrated in.

Macroeconomic conditions can be assessed by the IAA, at least one knowledgeable human providing input to the IAA, or a combination of the IAA and at least one knowledgeable human. For example, the IAA can assess interest rate trends (interest rate trends for US treasury bonds, for example) and how the yield curve is behaving. A human being can provide information which the IAA may have a harder time acquiring on its own, such as what the Federal Reserve's policies are on interest rates (rising, falling, holding steady) and its balance sheet (e.g. what type of bond purchases, maturities without replacement, outright sales) in the near future. The combination of input from humans on macroeconomic conditions, along with automated analysis of data by the IAA, provides a more powerful combination than using one but not the other.

The IAA 10 will generally have the capability to analyze price trends in securities on its own. However, there might be some cases where humans can provide input to make the IAA more effective.

The IAA is constantly monitoring how the stock markets is performing by sectors, as well as if there are significant differences in performance by market capitalization. While the IAA can obtain this information by monitoring individual stocks, a preferred way of doing this is by looking at the performance of well-designed funds which track sectors, industries, different market capitalizations, geographic regions, etc. The IAA also monitors major stock markets across the world.

In order to monitor performance by sector, a good set of funds to use is the Select Sector SPDR ETFs:
https://www.sectorspdr.com/sectorspdr/

The IAA tracks multiple interest rates from around the world including yields on US treasury securities across the full range of durations, from maturities of less than a month to yields on 30-year treasury bonds. The IAA also tracks sovereign bond yields from other countries (including all G7 countries, China, and several other countries) and central bank interest rates from these countries. Two of several interest rates the IAA tracks are the US 10-year treasury bond yield and the US federal funds rate.

The IAA maintains historical information on how different types of investments have performed during past market periods. It uses this information to make assessments on the optimal types of investments to use for future market periods. The types of market periods the IAA considers are diverse; it may consider several overlapping time periods. For example, the bull market after the 2007-2009 market crash commenced after Mar. 9, 2009. One set of market periods could be rallies since Mar. 9, 2009 not interrupted by a decline of at least x (where x could be 5%, 10%, etc). Another set of market periods could be declines of at least x % (where x could be 5%, 10%, etc) since 3/9/2009. Based on these market periods, the IAA has data on how different types of investments behave during rallies, as well as market declines.

In many cases, the past time periods the IAA 10 defines and uses to study past performance of investments are associated with at least one characteristic known to have an effect on investments. For example, time period t1 might be associated with a time period, e.g., from a starting point in time of the time period to an ending point in time for the time period, wherein the overall stock market was in a rising trend. Time period t2 might be associated with a period wherein the overall stock market was in a falling trend. Time period t3 might be associated with a period wherein the Federal Reserve was raising interest rates. Time period t4 might be associated with a period when the Federal Reserve was lowering interest rates. Time period t5 might be associated with a period when the Federal Reserve was stimulating markets through quantitative easing. Time period t6 might be associated with a period when the Federal Reserve was reducing its balance sheet (quantitative tightening). Time period t7 might be associated with the Federal Reserve suggesting a significant change in Federal Reserve policy (e.g. Jerome Powell's testimony to the Senate Banking Committee on Nov. 30, 2021, Ben Bernanke's 2013 comments sparking the taper tantrum). Time period t8 might be associated with a period when the Federal Reserve is tapering its bond purchases to reduce quantitative easing. Time period t9 might be associated with a major world event affecting a large number of people (e.g. major disease outbreak, major military invasion, major embargo/economic sanctions). Time period t10 might be associated with a recession. Time period t11 might be associated with a period of high inflation. Time periods for analyzing past performance of investments can be determined using other criteria as well.

It is possible to extend the analysis further back (e.g. back to 2000, 1980, etc.). While the earlier history of financial markets is important, it should be noted that more recent history may be more relevant, as financial markets have evolved and changed over time. It should also be noted that many commonly traded stocks and funds were not in existence before Mar. 9, 2009.

It is also possible to focus on time periods after Mar. 9, 2009. For example, the IAA has extensive analysis of performance during the most recent 5 and 10 year periods.

Since one of the features of the IAA 10 is to prevent losses during market downturns, it has data on how different types of investments performed during significant stock market downturns going back to at least the 1929 stock market crash. Some of the more recent stock market declines which are useful to understand and have data on are (in chronological order) the 1968-70 bear market (which was partly triggered by inflation, just as the stock market decline in 2022. Inflation was not brought under control until the 2^{nd} half of 1982. From November 1968-August 1982, S&P 500 lost over 60% of its value, adjusted for inflation), the 1973-74 bear market (triggered by soaring oil prices and high inflation, one of the 3 biggest declines in the S&P 500 after the Great Depression, the other two being the .com collapse in 2000-2002 and the 2007-2009 financial crisis), the 1980-82 bear market (triggered by fight against inflation, highest interest rates in the modern era), the 1987 stock market crash (S&P 500 and Dow both fell over 20% in a single day, their biggest single day declines), the 1990 stock market decline (precipitated by Iraq's invasion of Kuwait), 2000-2002.com collapse, 2007-2009 financial crisis, and all of the declines of 10% or more since 2009, especially the 2020 Covid stock market crash and the 2022 bear market.

For these declines, the IAA maintains data on the performance of different types of investments. It also maintains data on major events and their effect on financial markets during these downturns, such as the Arab oil embargo in 1973-1974, the effects of the September 11 terrorist attacks during the .com collapse, and the collapse of Bear Stearns and Lehman Brothers in 2008.

Other types of time periods the IAA maintains data on include intervals of interest rate trends. For example, the IAA maintains data on how different types of investments perform during periods where the Federal Reserve is raising interest rates such as 1994-1995, 2004-2006, and 2016-late 2018/early 2019. We are currently in a period of rising interest rates, and maintaining data on the current period is one of the functions of the IAA.

The IAA also maintains data on how different types of investments perform during periods when the Federal Reserve was cutting interest rates, such as 1989-1992, 2000-2003, 2007-2008, and 2019-2020. These interest rate cuts overlapped with recessions and periods of significant stock market declines, as interest rate reductions are a key tool used by the Federal Reserve to prop up financial markets in distress.

The federal funds rate set by the Federal Reserve has a significant effect on other interest rates, such as treasury bond interest rates. There is generally a positive correlation with other interest rates and the federal funds rate. Other interest rates tend to rise as the federal funds rate is increased and fall when the federal funds rate is cut. The correlation is not perfect. Furthermore, longer term rates may not be as affected by the federal funds rate as much as shorter term rates.

Regarding effect on financial markets, bond values decrease as their interest rates (i.e. yields) rise and increase as their yields decrease. Stock prices are helped by falling interest rates. By contrast, rising interest rates can have a negative effect on stock prices, particularly growth stocks. Growth stocks tend to outperform value stocks when interest rates are falling. When interest rates are rising, this may favor value stocks over growth stocks.

Bonds not held to maturity lose value with rising interest rates. An example of this was the period in the first half of 2022 when interest rates rose considerably and bonds lost considerable value.

This explains why it is useful for the IAA 10 to maintain information on interest rates and how it can use this information to make good investment decisions. We give more examples of this later on.

In recent years, quantitative easing (QE) has been used by several central banks, first by the Bank of Japan starting in 2001 and later by the US Federal Reserve and several European central banks in response to the 2007-2009 financial crisis. Quantitative easing is a monetary policy whereby a central bank purchases financial assets (typically bonds, but can include stocks as well) in order to inject money into the economy to expand economic activity and reduce bond interest rates. Since QE has a significant effect on financial markets, the IAA closely follows the QE policies, particularly those of the Federal Reserve. It stores data on how different investments perform in different periods of QE. It maintains data on how markets perform when the markets transition out of QE.

QE has generally kept interest rates lower than where they would otherwise be and has helped equity prices. When the Federal Reserve stops performing QE, it often has a negative effect on stock prices. For example, QE was a major factor (along with cutting the federal funds rate to close to 0) in providing support to the financial markets during the 2007-2009 stock market crash as well as during the Covid stock market crash in 2020. Without QE, both the stock and bond markets would have faced further volatility and losses. They also would not have rebounded as strongly as they did after Mar. 9, 2009 and Mar. 23, 2020. When the Federal Reserve ended its QE1, QE2, and QE3 programs, there was a clear decrease in stock returns on investment.

The Federal Reserve started withdrawing its QE support in November of 2021 while the stock market was near its all-time high to date (the inflation-adjusted peak for the total US stock market was Nov. 8, 2021). Since that time to the time this patent application is being written, the stock and bond markets have experienced considerable volatility and declines, particularly on an inflation-adjusted basis. A key reason for the poor performance of the markets recently has been the Federal Reserve's hawkish polices of raising interest rates to combat inflation and reducing its bond holdings.

This illustrates why it is useful for the IAA to maintain current data on interest rate policies and trends as well as other Federal Reserve policies such as QE or the opposite (known as quantitative tightening, which would describe the Federal Reserve's policies at the time this patent application is being written).

One specific statistic the IAA tracks is the Federal Reserve's balance sheet which indicates the total assets held by the Federal Reserve. Trends in the balance sheet indicate how much quantitative easing or tightening is taking place both recently and in the past. This information helps the IAA make more effective investment decisions.

The Federal Reserve can provide support to financial markets by keeping interest rates it controls low (right now, this would be the federal funds rate; it is impossible to say what rates it may control in the future), lowering interest rates it controls (the federal funds rate, as of now), as well as QE. By contrast, the Federal Reserve can reduce support to financial markets by raising interest rates it controls and/or quantitative tightening; this is typically done to fight inflation. Reducing quantitative easing by tapering bond purchases can also negatively impact financial markets.

Communications the Federal Reserve makes to the public can also convey whether the Federal Reserve is being supportive of financial markets or not. In 2022, the Federal Reserve has overall been quite hawkish in its comments which has had a negative effect on stock and bond prices.

The IAA can assess an overall level of support provided by the Federal Reserve for financial markets by examining the federal funds rate, its recent trends, and expected trends over the near future; quantitative easing and quantitative tightening policies if any, as well as recent public comments and written communications by the Federal Open Market Committee (FOMC). If the IAA assesses that the Federal Reserve is being supportive of financial markets, it can recommend an overweight position in stocks. If can also recommend buying at last one bond fund. If the IAA assesses that the Federal Reserve is being restrictive (i.e. not supportive of financial markets; this is typically done to try to fight inflation), then the IAA can recommend an underweight position in stocks; the IAA can also recommend an underweight position in bond funds.

When the Federal Reserve is providing support to the financial markets, the IAA would typically recommend having significant exposure to stocks; it could also recommend having exposure to bond funds.

By contrast, the Federal Reserve can reduce support to financial markets by raising interest rates it controls and/or quantitative tightening; this is typically done to fight inflation. When the Federal Reserve is reducing support to financial markets, the IAA 10 can recommend having less exposure to stocks; it can also recommend having less exposure to bond funds.

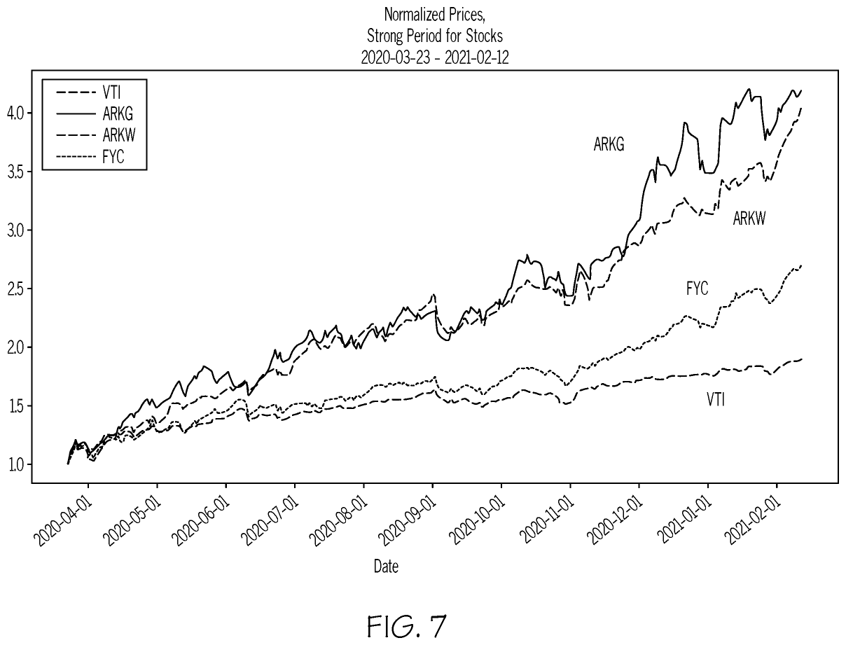

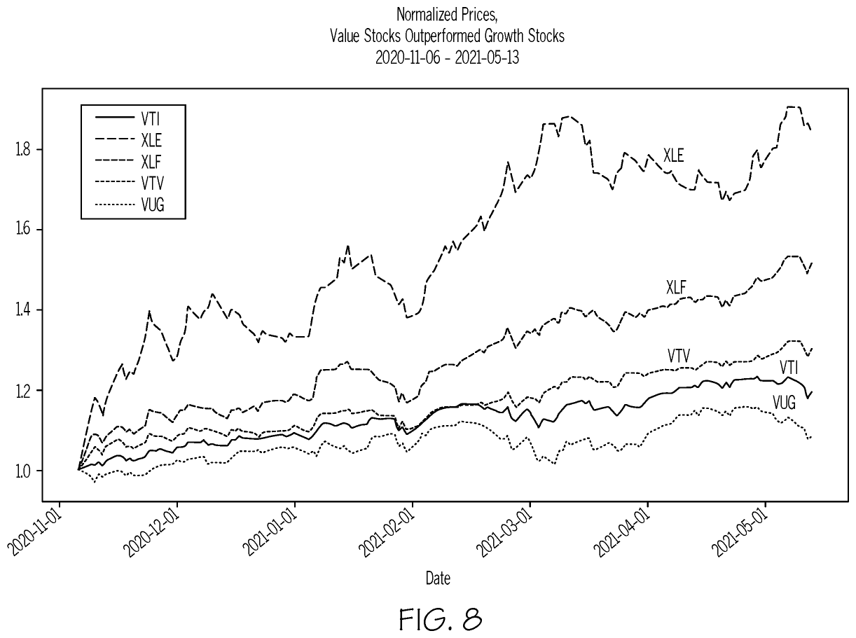

The IAA also has data on the performance of different types of securities for other types of time periods. For example, the period from Mar. 24, 2020 to around Feb. 12, 2021 was a unique period in financial markets because we were in the middle of a pandemic; there were many lockdowns across the world during that period. Despite the fact that the world was in a dire situation, the stock market was appreciating at an incredible rate. The S&P 500 gained 75.9% and the Nasdaq gained 105.5% in this period of under 11 months. The low interest rates and unprecedented QE from the Federal Reserve were critical factors in inflating equity prices, and the climate particularly favored speculative growth stocks, such as those in information technology and biotechnology (FIG. 7). That phase ended after Feb. 12, 2021 as interest rates rose, which caused many of the speculative growth stocks to decline considerably. Among other things, the IAA will use information from this period to help make investment decisions if a similar period should arise in the future.

The period from Nov. 9, 2020-May 13, 2020 is another example of a time period the IAA uses to analyze performance of different types of investments. On Nov. 9, 2020, Pfizer and BioNTech announced the success of their Covid vaccine trial, the most hopeful news in quite some time. This was a clear signal that the world had a good chance of emerging from Covid restrictions. This was an important boost for the stock market as a whole but particularly for value stocks, as many value stocks had been particularly hurt by the pandemic and accompanying lockdowns. The promise of a successful vaccine provided more of a relative boost to value stocks than to growth stocks (growth stocks fell from Nov. 9, 2020-Nov. 10, 2020 but started climbing after these 2 days).

Value stocks had been underperforming growth stocks for years. Now there was a specific catalyst to help value stocks outperform. From Nov. 9, 2020-May 13, 2021, value stocks significantly outperformed growth stocks (FIG. 8). The actual outperformance began on Sep. 1, 2020; however, the main reason was that a stock market downturn started in early September which hit growth harder; this was to be expected as growth was more richly valued at the time. When the markets recovered in the first week of November 2020, growth started to outperform again, and it looked like growth would continue outperforming value, continuing the previous pattern. The Covid vaccines changed that narrative.

Among other things, the IAA will use information from this period to help make investment decisions if a similar period should arise in the future.

After May 13, 2021, growth once again started to outperform value. As June came around, one key factor that provided an edge to growth was the spread of the Covid delta variant. Growth stocks, such as information technology stocks and especially semiconductor stocks, outperformed from May 13, 2021 through Nov. 29, 2021.

As mentioned previously, Nov. 30, 2021 was a significant day for the financial markets as Federal Reserve Chair Jerome Powell's testimony to the Senate Banking Committee indicated a new urgency to fight inflation which would mean a more hawkish monetary policy. This significantly affected financial markets. Growth stocks had previously been outperforming. After November 30, they started underperforming. Money started rotating into value stocks and especially into defensive stocks.

The period since Nov. 30, 2021 is particularly important for several reasons. It corresponds to the first time the Federal Reserve has been strongly fighting inflation in almost 40 years. The effects of the hawkish monetary policies employed by the Federal Reserve, how successful the fight against inflation will be, whether the economy will really go into recession (if it is not in a recession already), how high the federal funds rate will actually go, and how long it will take the financial markets to recover are still unknown as this patent application is being written. The IAA is collecting as much relevant information as it can to help it make more informed decisions in the future, particularly when similar types of situations occur.

It should be noted that there are many other periods that the IAA recognizes and analyzes; we have only summarized a limited number of time periods. Furthermore, there are multiple ways to classify time periods, and different time periods can overlap. The IAA considers alternative classifications for the overlapping time periods.

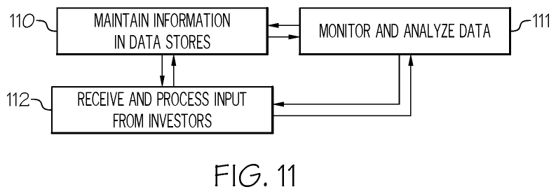

FIG. 11 depicts computational and data management tasks performed by the IAA 10. All of the steps in FIG. 11 are being executed continuously by one or more processors 102. In Step 110, investor data store 13, account data store 14, investment data store 15, and history data store 16 are continuously maintained and updated. As new data are received by the IAA 10, appropriate data stores are updated. The data stores are periodically backed up and replicated at geographically remote sites so that the data can be recovered in the event that the primary copy is lost. Multiple replicas can be created for additional fault tolerance.

In Step 111, the IAA is continuously monitoring and analyzing data in order to determine the best investments for clients. The data being analyzed include prices, price history, and past performance of a broad range of investments. Other data being continuously analyzed include the federal funds rate, yields for US treasury bonds of different maturities, inflation rates, monetary policy authorized by the US Federal Reserve, GDP, unemployment rates, and several other useful parameters. The IAA analyzes both current values and historical values for the data.

In Step 112, the IAA is continuously monitoring input provided by users, who could be investors, via the UI 19. Input provided by investors includes investor preferences for investments as well answers to questions targeted at assessing risk tolerance levels for investors. As another example of input provided by investors, the ABT 11 can manage individual bonds for investors. In order to help the ABT make appropriate bond purchases, investors can provide dates by which they will need money, as well as the amount of money that they will need. The IAA uses this information to select maturity dates for bonds to invest in, as well as the amount of money to invest.

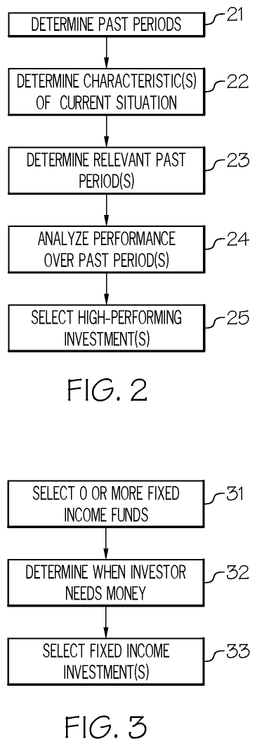

FIG. 2 depicts a method the IAA 10 can use to make effective investment decisions. In Step 21, the IAA identifies past time periods which are useful to analyze. Each past time period is associated with at least one characteristic known to have an effect on investments. For example, the time period from Feb. 19, 2020-Mar. 23, 2020 is associated with a falling stock market. The time period from Mar. 23, 2020-Nov. 8, 2021 is associated with a rising stock market. The time period from Aug. 4, 2021-Jun. 16, 2022 and beyond is associated with rising interest rates. Other characteristics past time periods are associated with include a falling interest rate, quantitative easing, quantitative tightening, a change in monetary policy, a recession, high inflation, and other characteristics.

In Step 22, the IAA determines at least one characteristic cl known to have an effect on investments corresponding to a current time period.

In Step 23, the IAA determines a subset s1 of past time periods identified in Step 21 wherein each time period in s1 is associated with cl.

In Step 24, the IAA analyzes performance of several investments during different time periods in s1.

In Step 25, the IAA selects at least one high-performing investment. Each high-performing investment i1 which the IAA selects should outperform a market index for its asset class. For stock investments, the market index could be the S&P 500, Nasdaq, Dow Jones Industrial Average, Wilshire 5000, Russell 2000, etc. For example, there could be multiple time periods p1, p2, p3, p4 in s1 after the inception of an investment i17. The IAA can determine an aggregate performance for i17 by computing quotients of the final value divided by the initial value for all 4 time periods and multiplying the quotients together. An aggregate performance for market indices can be computed the same way. The IAA can use these aggregate performance numbers to determine if i17 beats the market index.

If there are several high-performing investments, the IAA can chose the highest performing investment, h1. If h1 is highly volatile, this can introduce considerable risk. In order to pick an investment which has high risk-adjusted returns, the IAA uses Sharpe and Sortino ratios to assign a risk factor for h1. If the IAA is picking a single investment, then it will search for an investment with high returns and low Sortino (or Sharpe) ratios.

In order to diversify and amortize risk, the IAA can pick multiple investments which are not highly correlated. For example, the VOO S&P 500 stock index fund and the AGG bond fund would typically have less correlation than Microsoft and Apple stock. To limit risk, the IAA selects multiple investments which perform well during time periods in S1 but are not highly correlated with each other.

As we have described, past time periods can be selected based on a variety of different characteristics, including, but not limited to, a rising stock market, a falling stock market, a rising interest rate (the interest rate may correspond to a US treasury bond, for example), a falling interest rate, quantitative easing, quantitative tightening, a change in monetary policy, a recession, high inflation, etc.

The IAA also looks at economic conditions to assess different time periods (including the current one), make investments, and recommend investments. The IAA considers a number of economic indicators for these purposes including GDP, inflation, unemployment rates, job growth rates, purchasing managers' index (PMI), and others.

The IAA can also select past time periods, as well as refine the end points of past time periods, by comparing performance of investments in different candidate time periods. The idea is that a past time period can be defined based on performance characteristics of different types of investments. Here are some of the performance characteristics the IAA can use in defining past time periods:
Relative performance and/or correlation of growth and value stocks
Relative performance and/or correlation of different stock market sectors
Relative performance and/or correlation of small cap stocks to the overall stock market
Relative performance and/or correlation of stocks and bonds

The IAA can take a time range and break up that time range into periods having similar performance characteristics. For example, it can look at the relative performance of growth and value stocks (using a ratio of their returns on investment, for example) over the past n days (where n is a parameter) at multiple points in time in the time range and identify time periods where the relative performance does not change much and periods where there is a substantial change in relative performance. One way to determine if there is a substantial change in relative performance is to examine the performance of at least one growth fund, like VUG, and compare its performance to at least one value fund, like VTV, by dividing the total returns of VUG by the total returns of VTV over a period of n trading days, where n is an integer parameter. If a change in this ratio exceeds a threshold, the time at which this occurred could be a start (starting point) or end (ending point) of a past time period.

Alternatively, the IAA can examine a correlation between returns of VUG and returns of VTV. If a change in this correlation exceeds a threshold, the time at which this occurred could be a start or end of a past time period.

If a change in relative performance (and/or correlation) between a small cap stock fund like VTWO and a total stock market fund like VTI exceeds a threshold, the time at which this occurred could be a start or end of a past time period.

If a change in relative performance (and/or correlation) between a total stock market fund like VTI and a total bond market fund like AGG exceeds a threshold, the time at which this occurred could be a start or end of a past time period.

For comparing relative performance of different stock market sectors, the IAA can use the Select Sector SPDR ETFs:
https://www.sectorspdr.com/sectorspdr/

The IAA computes relative performance and correlation for each pair of sector ETFs. It determines how these values change over time. When a sum of changes in values over time indicating relative performance (and/or correlation) for each pair of sector ETFs exceeds a threshold, the time at which this occurred could be a starting point or an ending point of a past time period.

The IAA can make use of different sectors, such as the 3 defensive sectors: utilities (XLU ETF), consumer staples (XLP ETF), and health care (XLV ETF); information technology (XLK ETF); and energy (XLE ETF), along with oil prices. The IAA computes relative performance and correlation of these sector ETFs with a total stock market ETF such as VTI. For the 3 defensive sector ETFs, the IAA can compute an aggregate performance number (and/or correlation) so that the 3 defensive sectors are treated as a single entity. For energy and oil prices, the IAA can compute an aggregate performance number (and/or correlation) from XLE and at least one oil commodity fund, such as USL, USO, UGA, BNO, etc.

While this example uses the Select Sector SPDR ETFs, the IAA can use other ETFs as well to determine sector performance.

When any of the relative performance (and/or correlation) values described in the preceding paragraph exceed thresholds (the thresholds can differ for different sectors), the time at which this occurred could be a boundary (an ending point for one time period and a starting point for another time period) between distinct time periods.

In Step 23, past time periods in s1 might have different levels of similarity with the current time period. The IAA has techniques for quantitatively determining similarity of time periods. It is based on both characteristics of the time periods and performance of different investments in the time periods. Similarity scores are assigned to different economic characteristics, including but not limited to federal funds rate, treasury yields of different durations, interest rate trends, inflation rates and trend, oil prices and trends, etc. A similarity score is positively correlated with how similar a characteristic is in the current time period and a past time period.

The IAA also compares performance of a variety of investments in the recent past of the current time period to performance of the investments in past time periods to obtain additional similarity scores which are correlated with how similar performance is in the current time period and a past time period. In particular, the IAA compares performance of the overall stock market and bond market in the current time period and a past time period. It also compares a performance of growth, value, small cap, and stocks belonging to certain sectors to the overall stock market. For example, a relative performance of growth stocks to the overall stock market can be determined by dividing returns of the VUG ETF by returns of the VTI ETF. Earlier, we gave examples of funds which can be used to determine returns of value, small cap, and sector funds.

As mentioned previously, relative performance (compared to the overall stock market) of defensive sectors, the information technology sector, and the energy sector can be calculated by the IAA; additional similarity scores are determined based on these sectors which are correlated with how similar relative performances are in the current time period and a past time period.

The IAA uses the similarity scores to calculate aggregate similarity scores between the current time period and past time periods. A variety of formulas can be used to calculate aggregate similarity scores from similarity scores. One approach is to assign a constant weight, wi, to each similarity score, si. If there are n similarity scores, where n>3, the aggregate similarity score is the sum:

w1*s1+w2*w2+w3*s3+ . . . +wn*sn
where w1, w2, w3, wn are the weights for similarity scores s1, s2, s3, and sn.

The IAA uses aggregate similarity scores to more accurately select at least one high-performing investment, i1, in Step 25. The method for Step 25 described earlier determines performance of an investment over past time periods by weighting past time periods equally. A more sophisticated approach is to weight performance on past time periods by aggregate similarity scores. That way, past time periods with higher degrees of similarity to the current time period will be assigned a higher weight, while past time periods with lower degrees of similarity to the current time period will be assigned a lower weight.

An additional method of computing at least one high-performing investment in Step 25 is to use additional prediction models for the plurality of investments being considered and to pick a best prediction model, m1(i), for each investment i. m1(i7) would be the best prediction model for i7. The best prediction model for an investment, i7, would be the model which most closely predicts the performance of i7 (using metrics such as mean average error, root mean squared error, etc.; a best prediction model would have a least error). The IAA would then estimate the performance of an investment i5 by using model m1(i5).

The IAA can then choose an investment whose best prediction model results in the highest returns. In order to avoid choosing an investment which is too volatile or has too much downside risk (too much risk of a serious loss), the IAA can consider metrics like Sharpe and Sortino ratios to pick a high-performing investment which has less chance of incurring significant losses.

The models the IAA uses to predict the performance of an investment include the approaches described above for determining the performance of the investment in past time periods. The models also include regression models for determining the performance of the investment based on a variety of covariates including past performance of the investment, interest rates, inflation rates, employment data, GDP trends, and a variety of other economic data. For stock investments, other covariates include performance of different stock market indices as well as performance of different industries and sectors (which can be determined by performance of stock funds concentrated in the appropriate industries and sectors). The IAA 10 uses a variety of regression methods including linear regression with and without regularization (lasso, ridge, and elastic net), gradient boosting, random forest, support vector machines, k nearest neighbors, and others. The IAA also uses different types of neural networks and deep learning techniques for predicting investment performance.

While the IAA 10 provides a wide variety of investment possibilities to handle different macroeconomic and market conditions, some of the useful ones fall into the following categories:

Growth-oriented stocks. An example of a situation where such investments are likely to do well would be one where the stock market is rising, interest rates are not too high, and interest rates are falling, holding steady, or rising at a gradual rate.

Value-oriented stocks. An example of a situation where such investments are likely to do well would be one where money is rotating from growth stocks to value stocks, possibly due to rising interest rates.

Defensive stocks. These investments can be held in most parts of the investment cycle as they tend to be less volatile than most other types of stocks. Defensive stocks will outperform when markets are weak and there are fears of economic downturns.

Commodity-based stocks and futures.

We now give more details of these different types of securities and how the IAA 10 can use them to most effectively invest during different types of market conditions.

When the overall market is doing well and interest rates are not rising by a substantial amount (they could be falling, stable, or not rising by a substantial amount), growth stocks will often outperform. In these situations, good performance can often be obtained by investing in growth stocks. The IAA can recommend investing in growth stocks when it determines that interest rates are not rising by an amount exceeding a threshold. While the IAA can pick individual growth stocks to invest in, it also has information about a variety of growth funds to choose from. QQQ and VUG are examples of large-cap growth funds. VOT is an example of a mid-cap growth fund. FYC and DWAS are examples of small-cap growth funds.

Information technology is one of the sectors that usually outperforms when growth stocks are doing well. Within information technology, the semiconductor industry in particular can outperform during bull markets. While the IAA can pick individual information technology and semiconductor stocks, a preferred method is to pick good funds in those areas. IYW, FTEC, XLK, and VGT are good information technology ETFs which are weighted towards large information technology companies. There are several other funds as well, some focusing on specific segments of information technology. SOXX, SMH, and XSD are good semiconductor ETFs. SOXX and SMH are more heavily weighted to large semiconductor companies.

There are sometimes macroeconomic situations which favor certain types of growth stocks. For example, when Covid caused the world to lock down, companies which facilitated remote communication and shopping to allow the world to continue to function during lockdowns were critically important. The ARK Next Generation Internet ETF (ARKW) focused on such companies. Companies allowing electronic shopping were covered by funds such as Amplify Online Retail ETF (IBUY) and ProShares Online Retail ETF (ONLN).

Covid was in particular a health care crisis. This provided a boost to biotech companies. Funds such as ARK Genomic Revolution ETF (ARKG) and SPDR S&P Biotech ETF (XBI) soared during this period.

The IAA is able to direct investments to these specialized growth areas as called for by the macroeconomic situation. It is also sensitive to performance based on market capitalization. From Mar. 23, 2020 through Feb. 12, 2021, small cap growth was significantly outperforming. One way the IAA can take advantage of such opportunities is to invest in small cap growth funds like FYC. After Feb. 12, 2021, small cap stocks started to underperform. The IAA is sensitive to these changes, as it is constantly monitoring the performance of different parts of the stock market as well as interest rates.

The IAA 10 can customize growth investments based on investors' tolerance for risk. Diversified exposure to growth could be provided by investing in a Nasdaq index fund such as QQQ or QQQM. More concentrated exposure to the information technology sector can be provided by ETFs such as IYW, FTEC, XLK, and VGT. Investing specifically in semiconductor companies (a subset of information technology companies) incurs higher risk but also has the potential for higher rewards as well. SOXX, SMH, and XSD are good ETFs for gaining exposure to the semiconductor industry.

For riskier growth investments, there are funds such as ARKK and ARKW which are quite volatile but have the potential to generate high returns when market conditions are favoring growth stocks.

For investors who truly are seeking returns significantly above market averages and are willing to incur a high degree of risk, the IAA 10 allows investors to make leveraged investments. There are a number of leveraged funds investors can choose from. For example, UPRO and SPXL are ETFs that strive for three times the daily performance of the S&P 500 (minus expenses and fees). TQQQ strives for three times the daily performance of the Nasdaq 100 (minus expenses and fees). SOXL is a leveraged ETF for semiconductor stocks, and TECL is a leveraged ETF for technology companies.

The IAA will only recommend leveraged ETFs when market conditions are favorable for them. The IAA also has an Agile Investment Manager (AIM) 12 for investing money safely in very risky securities like leveraged ETFs which we describe later.

Sometimes, market conditions will favor value investments over growth investments. A good example was the period from March 2000-February 2007. During the .com era, a significant amount of money shifted from value to growth. It was clear by towards the end of the millennium that growth stocks and the Nasdaq were overvalued. Speculative growth stocks were being inflated at the cost of value stocks. It was not surprising when growth stocks started declining towards the end of March 2000.

While growth stocks were declining during the dot com collapse, money was rotating into value stocks. One could have avoided significant losses during the dot com collapse by investing in value stocks. For example, the FDVLX value mutual fund held up well during this period. If a situation similar to the dot com collapse were to arise again, the IAA could recognize how overvalued growth stocks were relative to value stocks. The IAA could shift money to value stocks and funds, away from growth. The FDVLX value mutual fund still exists. However, there are a much larger set of value funds to choose from. For example, large cap value ETFs include VTV, SPVU, RPV, and VLUE. RWK is a mid cap value ETF, while XSVM, RWJ, and SLYV are small cap value ETFs.

Note that the IAA has multiple ways of dealing with a sector rotation from growth stocks to value stocks:
1) Sell at least one growth stock/fund. For example, sell a growth fund like VUG. Because the overall US stock market is weighted in favor of growth stocks, the IAA can also reduce exposure to growth stocks by selling at least one S&P 500 fund like VOO or SPY, as well as selling at least one total stock market fund like VTI.
2) Buy at least one value stock/fund. For example, buy a value fund like VTV.
3) Sell at least one growth stock/fund and buy at least one value stock/fund.

There have been other more recent periods when value stocks have outperformed growth stocks which have been characterized by significant gains in interest rates. Higher and rising interest rates can favor value stocks over growth stocks. One period was from Sep. 1, 2020-May 13, 2021.

Within that period, the highest degree of outperformance happened from Feb. 16, 2021-Mar. 8, 2021, when the performance of growth deteriorated significantly as interest rates soared. The overall market (including the S&P 500 and Wilshire 5000) declined as money rotated out of the growth stocks. However, several value funds, and especially the energy and financial sectors, gained. The IAA can recognize these types of sector rotations into value both by the increases in interest rates and the trends in stock prices.

During interest rate surges of this type, financial stocks (e.g. bank stocks) tend to do particularly well. Thus, the IAA can purchase at least one financial stock/fund to try to generate above market returns. For example, it could purchase the XLF financial ETF and/or a bank ETF like KBWB and/or KRE.

Oil prices were also surging during this period. When this is the case, the IAA can purchase at least one energy stock, fund, and/or commodity fund (several examples are provided below) to generate above market returns.

A surge in interest rates along with a rotation from growth to value stocks also happened around Sep. 23, 2021-Oct. 4, 2021. Once again, the overall market (including the S&P 500 and Wilshire 5000) declined as money rotated out of growth stocks. However, several value funds, and especially the energy and financial sectors, gained. One of the things that was happening at this time was that the surge in Covid cases in the US from the Delta variant was waning and US Covid cases had started declining. This was bullish for value stocks, but particularly bullish for energy stocks. The IAA can use this information from interest rate trends, recent stock market price trends, and a major event like a pandemic to make intelligent stock trades; in this case, energy is the best candidate for outperformance, followed by financials, with overall value providing less alpha than energy or financials but still substantially outperforming growth.

The term “alpha” is intended to mean the ability of an investment (e.g., a security) to beat the overall market. The term “beta” is intended to mean a measure of how volatile an investment (e.g., a security) is relative to the overall market.

There was also a surge in interest rates from Sep. 29, 2016-Dec. 16, 2016 which benefited value over growth, and especially benefited bank stocks. The energy sector also outperformed; however, the energy sector did not do as well as the financial sector. A key reason was that the rise in oil prices was not as significant as the rise in interest rates. The rise in interest rates and the sector rotation into value stocks (with bank stocks really outperforming) was dramatically accelerated after the results of the 2016 US elections.

In these examples from 2021 and 2016, interest rates rose in the context of an overall bull market. Furthermore, they did not result from hawkish polices of the Federal Reserve; on the contrary, Federal Reserve policies were supportive of financial markets (and many would argue now that the Federal Reserve was being too dovish in 2021). In situations like these, the significant rise in interest rates tends to be transient, and growth stocks can be expected to rebound and start performing well again. Therefore, when the IAA detects a rebound in growth stocks and the macroeconomic environment is still favorable for growth stocks, it can start purchasing at least one growth stock. A relatively conservative approach would be to buy shares in an S&P 500 index fund like VOO or SPY, or even a total market stock fund like VTI; since growth companies constitute a significant portion of these index funds, buying shares in them will provide exposure to growth stocks. A more aggressive strategy providing more direct exposure to growth stocks would be to buy at least one specific growth stock and/or to buy shares in at least one growth fund such as VUG.

Money was rotating out of growth stocks as 2022 started and interest rates surged. At this point, inflation and expected hawkish policies from the Federal Reserve to bring inflation under control were key drivers of the market. The investment community was quite aware of the fact that the Federal Reserve was not inclined to support financial markets as it had for most of the previous several years. Bull markets can fuel inflation, so a decline in stock prices was arguably a desired outcome to bring inflation under control (as long as the stock market decline was not too severe). In a situation like this, increases in interest rates can be expected to be considerably more significant and last over a considerably longer period than the 2016 and 2021 interest rate surges. Similarly, growth stocks would be expected to underperform by significantly more, and the period over which the underperformance occurs would likely be considerably longer.

In this type of a situation, the IAA 10 would recommend having a reduced exposure to growth stocks (note that reduced exposure includes the possibility of no exposure, i.e. not investing in any growth stocks) for a considerably longer period of time.

### Investment Exposure to Commodities

The price of commodities can fluctuate considerably. The IAA allows investors to benefit from rising commodity prices by investing in both companies associated with specific commodities, as well as the commodities themselves. Commodities can be divided into multiple categories. Common categories for commodities are:
Energy, such as oil, natural gas;
Food, agricultural products, such as corn, wheat, soybeans, sugar;
Base metals, such as copper, aluminum, zinc, nickel; and
Precious metals, such as gold, silver, platinum, and palladium.

The IAA allows investors to invest in commodities in multiple ways, including:
Investing in diversified commodity funds such as PDBC and GSG.
Investing in commodity funds focused on a particular type of commodity. For example, the TAGS and DBA ETFs hold futures in agricultural commodities. The DBB and BCIM ETFs hold futures in base metals.
Investing in stocks of companies whose businesses are based on commodities. For example, for someone interested in investing in base metals, buying stocks of particular companies like AA is one possibility. Alternatively, one can gain exposure to a broad set of stocks related to base metals by investing in funds such as XME and XBM.TO (i.e. the XBM ETF trades on the Toronto stock exchange).

Some investors chose to invest in commodities for a more diversified portfolio. Others may be more interested in investing in commodities to improve returns. Commodity prices do not always go up and can fluctuate considerably. Thus, a buy-and-hold strategy of investing in commodities over an extended period of time will not generate optimal returns. A better strategy, which the IAA uses, is to opportunistically invest in commodities when they are undervalued and/or there are economic reasons to expect increasing prices for commodities.

The IAA is tracking many economic indicators, including the strength of the dollar. The dollar index is a quantitative method for tracking dollar's strength relative to other currencies. Commodity prices generally rise when the dollar is weak; conversely, when the dollar is strong, commodity prices tend to rise less or may decline. There is an inverse correlation between the dollar index and commodity prices. If the dollar index is falling, that helps commodity prices rise, helping commodity investments. If the dollar index is falling, that hinders growth in commodity prices, causing commodity investments to perform poorly. The IAA considers dollar strength and the dollar index in making decisions about when to invest in commodities, and how much.

The IAA looks at periods when commodities appear to be underpriced. When it encounters such a period, it will recommend investing in the commodity. A typical example of an underpriced commodity is after its price has crashed around the time of a significant stock market decline. After the commodity price starts recovering, which is typically around the time the stock market is recovering (although the exact time the commodity price starts recovering may differ a bit from the exact time the stock market starts recovering), that is often a good time to invest in the commodity. The IAA can identify these recoveries in price in both commodities and the stock market and make recommendations to invest when it identifies a recovery from a crash.

After the Covid stock market crash, there were multiple clear signals to invest in commodities, such as oil and natural gas. When the world shut down due to Covid, oil prices plunged to historically low levels. On Apr. 20, 2020, oil was trading at negative prices. This was a clear anomaly and a sign that this was a good time to buy oil futures. The IAA identifies price anomalies like this and makes intelligent investment decisions based on it. In this type of situation, it is not necessary to invest exactly on Apr. 20, 2020 when oil had a negative price. One could wait for the rebound from negative territory to see that the price was clearly in a positive trend before investing. The IAA can be configured based on how aggressive the investor is. In the aggressive mode, the money would be quickly invested on Apr. 20, 2020 or very shortly afterwards. For a more conservative investor, the IAA would more gradually invest money as oil prices rebounded and continued to show an upward trend. Later on, we explain the IAA features for safely investing in a security considered risky, and how the IAA minimizes losses.

Another example of a clear signal to invest in energy which the IAA can pick up occurred in the first week of November 2020. From Jul. 2, 2008-Nov. 6, 2020, the energy sector was the worst performing sector by a significant margin. The XLE energy sector ETF lost 40.8% of its value during this period, while the VTI total stock market fund returned 208.3%. The situation was about to change significantly.

On Nov. 9, 2020, Pfizer and BioNTech announced the success of their Covid vaccine trial, the most hopeful news in quite some time. This was a clear signal that the world had a good chance of emerging from Covid restrictions. This development was particularly bullish for energy stocks which had been decimated by Covid lockdowns after years of underperformance driven by low oil prices. Since energy stocks were starting from such a low level, this was as good a time as any to invest in the energy sector. From Nov. 9, 2020-Jun. 8, 2022, the energy sector was the best performing sector by a significant amount, gaining 241.6% compared with 17.5% for the VTI total stock market fund. Thus, a breakthrough development which has the potential to alleviate a major catastrophe the world is suffering from is a good example of the type of information the IAA can interpret to make the right investment decisions.

We now give more details of how the IAA allows users to invest in energy-related stocks and commodities. Examples of energy stocks include XOM, CVX, COP, and others. One can also invest in energy funds which hold investments in a basket of energy companies. Examples of energy funds include the ETFs XLE, IEO, and PXE. It should be noted that energy stocks are not the only way to financially profit from rising energy costs.

The IAA offers different ways for investors to profit from gains in the energy sector. Investors can provide preferences indicating their choices for types of energy investing. One option would be to pick different energy stocks and/or different funds. The IAA can invest in the XLE ETF to provide balanced exposure to the energy sector. The IEO ETF would generally beat XLE when energy stocks are doing well but trail XLE when energy stocks are doing poorly. The PXE is even more extreme. It generally does better than IEO and XLE when energy stocks are doing well but does worse than IEO and XLE when energy stocks are doing poorly. Thus, an investor desiring balanced exposure to the energy sector could select the XLE ETF. An investor interested in higher returns when energy stocks are doing well and also willing to tolerate more losses when energy stocks are not doing well could select PXE. An investor interested in returns in between XLE and PXE could choose IEO.

Investors willing to tolerate a high degree of risk in pursuit of high returns could choose a leveraged energy ETF such as DIX, ERX, or GUSH, as well as leveraged ETNs such as NRGU. These leveraged ETFs do extremely well when energy stocks are rising. They are quite risky, however, as they can lose a considerable amount of money if energy stocks are falling.

The IAA can select from these different energy funds based on investor risk tolerance levels and other preferences from investors. As we discuss below, ESG (environmental, social, and governance) can make some investors reluctant to invest in energy stocks. The IAA can also select a combination of energy funds and individual stocks to balance out potential investment gains versus potential losses based on the risks of the funds and individual stocks.

Energy stocks are highly correlated with the price of energy commodities, most notably oil and natural gas. Thus, it is possible to invest in energy commodities in addition to or instead of energy stocks. Buying the actual commodities themselves would be extremely difficult for most investors. Instead, one can buy futures in the commodities. For investors who do not directly invest in commodity futures, there are several funds, as well as exchange-traded notes (ETNs) which invest in commodity futures. That way, investors can buy shares of the funds and/or ETNs so that they do not have to directly trade futures. Examples of ETFs which invest in oil futures include USL, USO, and BNO. There are also several funds (as well as ETNs) which invest in a variety of commodities, for which energy is one of multiple components. Examples of these funds include PDBC and GSG. Although energy is just one component of these commodity funds, the performance of these funds tends to be highly correlated with oil prices.

Many value-oriented funds, as well as high dividend funds, have performance which is correlated with energy stocks but are not as volatile. They do not gain as much when energy stocks soar, but do not lose as much when energy stocks do poorly. Examples of these value funds include VTV, VLUE, SPVU, and RPV. Examples of these high dividend funds include FDL, DHS, and HDV. The IAA allows investors to choose these types of funds, which benefit when energy stocks rise but are considerably less concentrated in energy stocks. The Saudi Arabia ETFs KSA and FLSA are also correlated with energy stocks. They offer investors another alternative to gain exposure to trends in energy stocks while investing across a broader variety of sectors.

Many investors have ESG (environmental, social, and governance) concerns. They may not want to directly invest in energy companies because of these concerns. The IAA provides a variety of types of investments as described above for benefiting from trends in energy stocks without requiring direct investment concentrated in energy companies. For example, investing in commodity futures funds (such as the ones described earlier) does not involve investing in any particular company. An ESG investor may be more comfortable investing in these types of funds than investing in energy company stocks.

An ESG investor might be more comfortable investing in a value or high dividend fund because the holdings are not as concentrated in energy companies. Such funds will benefit somewhat when energy stocks do well. They will also not lose as much when energy stocks go down. They tend to be considerably less volatile than energy funds, a factor which many investors value.

It should be noted that shareholders in energy companies typically want the oil (and possibly natural gas as well) supply to be limited, as this results in higher oil prices which benefit energy stocks. Higher oil prices can reduce demand for oil, resulting in fewer greenhouse gases being emitted. An argument can thus be made that shareholders in energy companies can be a positive force in reducing fossil fuel consumption. The point is that differing arguments can be made in what constitutes ethical ESG investing. Individual investors may have their own personal preferences. The multiple options the IAA 10 provides for investment options allow different investors to pick appropriate portfolios based on what they consider to be ethical ESG investing.

### Reducing Losses During Market Downturns

One of the key problems in investing in stocks is that the market can exhibit considerable volatility. There can be considerable downturns where stocks lose a significant amount of money. A key question is how to avoid such losses.

If one plans on selling stocks before a decline, a problem is how to know when to get out of the stock market to avoid the decline and how to know when to go back into the stock market, as it is difficult to know exactly when the market has reached its lowest point. Downturns which cause the S&P 500 to fall over 10% are problematic. Good methods for mitigating losses during this period are desirable. In many cases, it is not necessary to pull the vast majority out of the stock market during these times. Instead, it is preferable to move money into the right sectors of the stock market. A balanced portfolio should always have a significant chunk of money outside the stock market and in other assets such as bonds, cash, real estate, commodities, etc. Supposing the normal situation is to have 60% of a portfolio invested in stocks (could include individual stocks, ETFs, mutual funds, etc). The IAA, in conjunction with at least one knowledgeable human, can make an assessment that macroeconomic conditions present a risk to the performance of the stock market. A risk averse investor might choose to reduce equity holdings based on the risk factors, even if the stock market has not started declining. That could lead to reduced returns if the stock market decline never materializes. A more balanced approach would be to wait until the market starts declining and then make the best assessment of how to respond to the decline.

If the markets start declining (e.g. if at least one major stock market index such as the S&P 500 is declining) and the IAA determines that the decline is due to the risk of an economic slowdown but not a complete crash (A human expert can aid the IAA in making this decision. Alternatively, the decision can be made by the IAA without input from a human being. A complete crash in this case would be something like the Great Depression, 2008 financial crash, market crash when the economy shut down in response to Covid, etc), the IAA could shift equities to defensive sectors. The IAA might also reduce equity holdings. For example, a reduction from 60% invested in stocks to 45-50% invested in stocks might be appropriate depending on the risk tolerance level of the investor. A risk-averse investor might want a drastic cut in equity allocation, such as from 50% down to 20%. While the IAA would allow this, it would also warn the investor that such a reduction in equities could risk future performance, as it could be difficult to get back into the market at the right time when it rebounds.

Defensive sectors, typically utilities, consumer staples, and/or health care, hold up better than other sectors when economic conditions deteriorate. Money will often rotate into the defensive sectors from other sectors (e.g. cyclical sectors) when the economy appears to be slowing.

Thus, the IAA will shift equity holdings into defensive holdings. Three examples of defensive holdings would be stocks in utilities, consumer staples, and/or health care. This list is not exhaustive. In some cases, high dividend stocks can function effectively as defensive stocks. It may also be desirable to move money into stocks with lower volatility, even if the identified lower volatility stocks are not all in utilities, consumer staples, and/or health care.

We mentioned previously that funds can be used, in addition to stocks. There are a number of funds which can be used for the defensive holdings in utilities, consumer staples, and/or health care. The IAA can invest money in the XLU and/or FXU utility ETFs. For consumer staples, the IAA could use the XLP, IYK, and/or RHS ETFs. Health care ETFs include XLV and IYH, as well as PPH for pharmaceutical companies. In some cases, it may be appropriate for the IAA to invest money in high dividend stocks which can be accomplished by investing in the FDL, DHS, and/or HDV ETFs. In other cases, it may be appropriate for the IAA to invest in stocks with low volatility, which can be achieved by investing in the USMV and/or LVHI ETFs.

As a stock market downturn unfolds, the IAA might overweight utility stocks relative to the overall stock market. If the stock market downturn lasts a considerable amount of time, utility stocks might start underperforming. In that case, the IAA might sell at least one utility stock. The IAA might also buy at least one health care stock; if health care is outperforming in this later stage of a market downturn while utility stocks have started to underperform, then the IAA will achieve improved performance by shifting money from utility stocks to health care stocks.

The IAA can also use defensive stocks, as well as low volatility stocks, in bull markets as well as bear markets, to more safely invest a higher percentage of a portfolio in stocks, as the defensive and/or low volatility stocks will likely incur smaller losses if the stock market starts declining. For example, a portfolio with 70% invested in an S&P 500 index fund incurs significant risk if the stock market starts declining. A portfolio with 50% in an S&P 500 fund and 20% in defensive stocks and/or low volatility stocks would incur less risk because the 20% in defensive and/or low volatility stocks will likely lose less value than an equivalent amount of money invested in an S&P 500 index fund if the stock market starts declining.

There are other sectors and funds the IAA 10 can use to invest money in during stock market downturns. For example, we previously described several scenarios in which it was appropriate to invest in value stocks and/or funds during stock market declines.

The IAA is making intelligent choices of which parts of the market are likely to hold up best in the near future; the IAA can shift money to these parts of the market.

During major stock market downturns, it can be the case that energy prices are rising significantly. This happened during the 1973-74 stock market crash when the S&P 500 declined 48%. It also happened during the earlier part of the 2007-2009 stock market crash in which the S&P 500 declined 57%. It also happened during the stock market decline in 2022. Spiking energy costs can hurt the economy and exacerbate inflation which are bad for the stock market.

Investing in energy stocks and/or commodities can mitigate the effects of the stock market downturn and possibly lead to gains while the overall market is declining. We explained earlier how the IAA provides a range of ways to invest in energy stocks and commodities.

One point is that when commodity prices are spiking, they can quickly plummet after reaching a peak. This happened to oil prices in July 2008. They reached their highest value (in actual dollars and constant dollars) that month. The price quickly plummeted, and energy stocks crashed.

After Russia invaded Ukraine, oil prices originally soared, reaching a peak on Mar. 8, 2022. The high price could not be sustained, and oil prices fell more than 20% in a week. While the prices rose again through June 8, they fell almost 30% through mid-August. After March 8, oil was no longer a strictly rising commodity. It had become extremely volatile, with experts having dramatically different views of its future price.

The IAA is sensitive to price volatility and would warn investors of the unsustainability of the price spike leading up to March 8 as well as the volatility in prices after March 8.

The IAA can also reduce the percentage of money allocated to stock investments when it perceives that the markets are at considerable risk of falling significantly. In extreme cases, such as the 2007-2009 financial crisis and the onset of the Covid-19 pandemic when countries all over the world locked down, the IAA will sell stock investments. A question is how to choose when to sell. In order to answer this question, we show how the IAA could have handled those situations if it had existed back then.

The downturn in stocks during the 2007-2009 financial crisis actually started after Oct. 9, 2007 with the S&P 500 closing at its lowest price on Mar. 9, 2009. There were plenty of opportunities to reduce equity holdings during this period. For whatever remaining equities were held as of Aug. 28, 2008, the IAA would likely have recommended selling them soon afterwards as it was clear that the financial system was imploding and stock prices were plummeting.

During Covid, it was clear by mid-February that the threat to the world was quite serious. The markets started declining on February 19, with 7 straight days of declines. The IAA would surely have recognized the need to sell equities in February based on the serious information on Covid as well as the price action in the stock markets.

Another question is how to know when to start increasing stock holdings after selling stocks in anticipation of a downturn. In the case of the 2007-2009 financial crisis and Covid 19, the conditions were so extreme that the Federal Reserve intervened by cutting the federal funds rate close to 0 and implementing quantitative easing. These were critically important to helping the stock markets rebound. Once the Federal Reserve provides significant support like this to a crashing market, the IAA would follow the price trends to see when the market (e.g. S&P 500) stops declining and shows some gains. At this point, the IAA would start buying stocks, increasing equity purchases if the stock market continues to gain, or selling equities if the market starts declining significantly again. The rebounds from these major crashes tend to be steep when they occur. Thus, when ta true rebound occurs, the IAA will be able to increase its equity holdings as the rally proceeds until the equity holdings are at the target amount (e.g. 60% is often used as a target, although the actual amount will vary depending on the risk profile of the investor). The rate at which the IAA buys stocks during a rally depends on the investor's preferences. A conservative investor would buy stocks more gradually. A more aggressive investor will buy stocks at a faster rate.

These two examples are extreme, because they involved crises of a kind that are relatively rare. Covid-19 was the worst pandemic since the 1918 flu pandemic. The 2007-2009 financial crisis is considered by many to have been the worst economic downturn in the US since the Great Depression. One question is how to sell stocks to avoid losses during more mundane stock market downturns.

It should be noted that it is not easy to time market exits and entrances to avoid market losses. If an investor waits too long to sell, significant losses may already have occurred. If an investor sells in anticipation of a market downturn, the market may actually go up before the investor reinvests the money in the stock market.

The IAA, possibly in conjunction with at least one human financial expert, can make a determination that the stock market is at risk of a significant downturn in the near future. This assessment would be made based on macroeconomic conditions, as well as recent stock market price action. For example, when the stock market started to decline after Jan. 3, 2022, the IAA could respond to this event with a combination of reducing stock holdings and rotating into defensive and/or value stocks (and possibly energy stocks and/or oil future funds as well, as oil prices were rising at a considerable rate). There were numerous warning signs that the overall stock market was due for a downturn. It was known that the Federal Reserve would be pursuing hawkish monetary policy to try to reduce inflation; this would clearly have a negative impact on the stock and bond markets. Oil prices were rising, further fueling inflation. Covid cases were elevated in several countries, including the US, as the omicron variant spread like wildfire.

The overall stock market had met resistance to going appreciably higher after a rally that peaked on Nov. 8, 2021. Even though the closing peak of the S&P 500 was on Jan. 3, 2022 (the intra-day peak was the next day), small cap stocks had started declining after Nov. 8, 2021. The Wilshire 5000 total US stock market index reached its intra-day peak on Nov. 5, 2021 and its closing peak on Nov. 8, 2021. While value stocks initially gained as money rotated from growth to value in early January, value stocks started tumbling along with growth stocks after January 14. This was a clear indication to reduce equity holdings.

The IAA can also consider at least one indicator of overbought stocks in determining when to sell at least one stock, such as relative strength index (RSI), stochastic oscillators, moving average convergence divergence (MACD), and others.

When the IAA has made a determination (possibly in consultation with at least one human financial expert) that the risks of a (further) market downturn are sufficient to justify selling stocks, it can sell stocks aggressively, or more conservatively, depending on investor preferences. In aggressive mode, the IAA would sell a significant amount of stocks right away. If the stock market subsequently declined and risks for further declines remained elevated, the IAA might sell more stocks. In a more conservative mode, the IAA 10 would sell a limited amount of stocks and continue to assess price movements and macroeconomic risks to determine what to do next. If the stock market subsequently declined and risks for further declines remained elevated, then the IAA might sell more stocks. If the risk for further declines decreases, then the IAA might choose not to sell more stocks.

Using this approach, the IAA can considerably reduce losses when there is an extended decline in stocks. Once the stock market starts declining, the IAA starts selling stocks. If the decline continues, the IAA will sell more stocks until it has a sufficiently reduced position in stocks. The rate at which the IAA sells stocks can be configured. A high rate means that during an extended period of stock market declines, the IAA will relatively quickly move the portfolio to a sufficiently reduced position in stocks, which will minimize investment losses. The drawback to a high rate of selling stocks is that if the stock market decline does not continue and quickly starts rising, investment losses due to having less money invested when the stock market rises will be higher.

Buying Back into the Stock Market after a Stock Market Decline

One of the issues is how the IAA should re-invest in stocks after it has sold stocks to try to avoid a predicted stock market decline. If it maintains an artificially low position in stocks after the market has rebounded and is rising, this could reduce returns.

One method is to use macroeconomic factors, along with stock prices and valuations, to assess the risk of further declines. For example, if the stock market has declined and the Federal Reserve has in response reduced the federal funds rate, increased quantitative easing, and/or decreased quantitative tightening, such actions could help the stock market and serve as an indicator that it is a good time to buy stocks. (Most declines will not be of enough significance to cause the Federal Reserve to change the federal funds rate or modify its quantitative easing/quantitative tightening policies.)

The price movement of stocks also can serve as an indicator of when it is appropriate to start buying stocks. Once the decline stops and the stock market starts rising, this could serve as an indicator to start buying stocks. In some cases, if the decline in stock prices either slows or stops, the IAA can start buying stocks to be able to benefit from an anticipated rise in stock prices, even if that rise has not yet occurred; this allows the investor to benefit from a sharp rebound which often comes very soon after a market low.

The IAA can also consider at least one volatility index to determine when it is appropriate to start buying stocks. A volatility index is an indication of market expectations for near-term price changes in the stock market. The CBOE volatility index (abbreviated VIX) is an example of a volatility index. The VIX is designed to measure 30-day expected volatility of the U.S. stock market. It is derived from real-time, mid-quote prices of S&P 500 index call and put options. When the VIX is at an elevated level (above 30, for example), this indicates a high degree of volatility along with an elevated risk of declines in the stock market in the near future. When the VIX starts declining from an elevated level, this can be an indication that the stock market decline is ending for the time being. The IAA determines an elevated level of the VIX from recent volatility levels. While a VIX reading of 30 is often considered to be a high level, the IAA can customize a high volatility threshold based on recent past periods when the VIX has reached a peak level during a market downturn before declining. One possibility is to determine a high volatility threshold by averaging peak values of the VIX over the past year. Another possibility is to determine a high volatility threshold by considering peak values of the VIX over a different length of time. Yet another possibility is to set the high volatility threshold to a number, such as 30.

Once the VIX exceeds the high volatility threshold and starts declining, the IAA can consider this as a signal that the stock market will end its decline soon, if it has not done so already.

The IAA can buy at least one stock after the VIX exceeds the high volatility threshold and starts declining even if the stock market has not stopped declining, in anticipation of an upcoming end to stock market declines. Alternatively, after the VIX exceeds the high volatility threshold and starts declining, the IAA can wait until the stock market stops declining before buying at least one stock.

The IAA can also use other types of volatility indices besides the VIX to determine when it is appropriate to start buying stocks in a similar manner as described above.

The IAA can also consider at least one indicator of oversold stocks in determining when to buy at least one stock, such as relative strength index (RSI), stochastic oscillators, moving average convergence divergence (MACD), and others.

The IAA can also look at past stock market declines to determine when a current market decline might be coming to an end. Once a market decline from a previous peak (also referred to as a drawdown) reaches a level which is high by historical standards, that suggests that the market may be oversold and is due for a rebound soon. For example, an oversold threshold level, o1, can be determined by studying the losses in past market declines (and the magnitude of these losses) which were not interrupted by relief rallies. Once losses in a current market decline (not interrupted by a relief rally) exceed o1, this suggests that a rebound might occur in the near future. The IAA can start buying stocks once this occurs. Alternatively, the IAA can wait for other indicators to indicate that the decline is coming to an end, such as a rebound in stock prices.

To summarize, the IAA can determine when to buy at least one stock by considering a number of factors, including but not limited to macroeconomic factors, such as how the Federal Reserve responds to the downturn (if the decline is of enough significance to warrant a response from the Federal Reserve; for many declines, this will not be the case), stock valuations, changes in stock prices (such as when the markets show signs of rebounding from the downturn), volatility futures and options, indicators of oversold stocks, and past data on market declines.

The IAA can buy stocks aggressively, or more conservatively, depending on investor preferences. In aggressive mode, the IAA would buy a significant amount of stocks right away. If the stock market then rises and conditions for further increases in stock prices appear favorable, the IAA might buy more stocks. In a more conservative mode, the IAA would buy a smaller amount of stocks than with the more aggressive mode and continue to assess price movements and macroeconomic risks to determine what to do next. If the stock market subsequently rose and conditions for further increases in stock prices appeared favorable, then the IAA might buy more stocks but at a slower rate than with the aggressive mode. If the risks of stock declines become significant, then the IAA might choose not to buy more stocks.

The IAA has a variety of options for the type (s) of stocks it chooses to purchase. It could buy an S&P 500 stock fund such as VOO and/or a total market fund such as VTI. It could also buy a growth fund such as VUG. It could also purchase a technology fund such as XLK. It could also purchase at least one semiconductor stock and/or at least one semiconductor fund, such as SOXX, SMH, XSD, etc. The IAA can also purchase other types of stocks.

If commodity prices, (e.g. oil, etc.) declined during the stock market downturn and the IAA assesses that commodity prices may now start increasing, the IAA might purchase at least one stock associated with a major commodity (e.g. XOM stock, XLE fund, etc.) and/or at least one commodity fund (e.g. USO, USL, UGA, GSG, etc.). We described elsewhere in the patent application how to invest in commodities; the same principles apply here.

In many cases, stocks of a particular industry segment which fell significantly (more than the overall market) rise significantly (more than the overall market) when the stock market rebounds from the decline. Thus, the IAA 10 can buy at least one stock from an industry sector or segment which fell by more than the overall market average during the stock market decline in anticipation that it will gain significantly during a rebound from the decline.

In some cases, the IAA may buy stocks as a rally gets underway, but then the rally loses steam and stocks start declining again. If the risk of further declines is significant, the IAA might sell stocks again using the same techniques described above and then use the techniques described above to determine when to start buying stocks again.

Mitigating Effects of Stock Market Declines with Bonds

During many stock market downturns, the bond market can gain in value while stocks are declining. While the stocks are declining, money is often rotating into bonds. This causes the bond values to rise, while their yields fall, as bond yields are inversely correlated with their values. It should be noted that when financial markets are seriously stressed, which happened during the 2007-2009 financial crisis as well as during the Covid market crash in 2020, lower-quality bonds (e.g. junk bonds) are not a safe investment. US treasury securities are generally considered to be among the safest investments, and demand for them often soars when other assets are at risk.

When the stock market is declining, the IAA is monitoring interest rates and the bond market to assess whether it is advantageous to move money to bonds. If the bond market is holding up well and interest rates are falling, the IAA will move money into at least one bond or bond fund. If the Federal Reserve is lowering the federal funds rate during the decline, this can provide an added boost to bonds, and the IAA uses this information to buy more bonds.

The IAA can buy bonds in a number of ways. It can buy bond funds, including total bond market funds such as AGG and BND. In some cases, it may be desirable to invest specifically in US treasury securities. When financial markets are really in trouble as described above, US treasury securities will be safer than other types of debt. The IAA can buy short-term US treasury bond funds like VGSH which are less susceptible to changes in interest rates than longer-term bond funds. It can also buy intermediate-term US treasury bond funds like VGIT which have more susceptibility to changes in interest rates than shorter-term bond funds but usually have higher yields and will do better if interest rates fall, which often happens in stock market downturns.

The IAA can also buy long-term US treasury bond funds like TLT and VGLT which have higher susceptibility to interest rate changes than intermediate or short-term funds but usually have higher yields. These bond funds will gain significantly if interest rates fall.

In order to gain the most alpha when interest rates are falling, the IAA can invest in zero coupon long-term US treasury bonds. It can do so by investing in a fund such as ZROZ and EDV. ZROZ would be a fund which provides the most alpha when interest rates fall. It is also subject to the highest losses when interest rates rise.

The IAA can invest in individual bonds, and not just bond funds. For example, during a period in which the stock market seems at risk for a downturn and interest rates are falling, it can invest in a zero-coupon bond with a duration close to 30 years. This bond will do extremely well if interest rates fall.

It should be noted that bonds do not always do well when stocks fall. As stocks fell from Jan. 3, 2022-Jun. 16, 2022, bonds also fell considerably as the Federal Reserve was raising interest rates considerably to try to fight inflation. The IAA recognizes these situations and will not move money to bond funds if bond values are falling significantly, along with stocks.

### Automated Bond Tracker

The IAA can include an Automated Bond Tracker (ABT) 11 for managing fixed income securities (bonds, CDs, etc.) such as bond investments. The ABT provides a number of features:
There are different types of fixed income securities which are appropriate for different market conditions. The ABT 11 invests in the right type of fixed income securities based on market conditions.
For bonds, the ABT 11 allows investors to invest in individual bonds, and not just bond funds. The maturities of the bonds can be selected so that investors can hold them to maturity. That way, the return on such a bond will not be affected by fluctuating interest rates. One of the issues with investing in bond funds is that the funds can do poorly when interest rates rise. This has been a major problem recently as rising interest rates have hurt bond fund performance. The ABT manages individual bond holdings (e.g. individual US treasury bonds) so that they can be held to maturity; when the bonds are held to maturity, their values will not be affected by changing interest rates. In particular, the investor will not lose money if interest rates rise.

Previously, we mentioned that the IAA 10 can determine investor preferences, as well as investor risk tolerance levels, based on input from investors. This information is used by the ABT to select appropriate fixed income securities to invest in.

FIG. 3 depicts a method the ABT 11 can use to manage fixed-income securities. In Step 31, the ABT 11 selects 0 or more fixed-income funds based on the current macroeconomic and market conditions. For example, if the Federal Reserve is in the process of cutting interest rates, the ABT might select at least one long-term treasury bond fund, such as ZROZ, TLT, VGLT, etc. If the consumer price index (CPI) is currently elevated, the ABT might select at least one inflation-protected bond fund, e.g. SPIP, TIP, etc. If the Federal Reserve is aggressively raising interest rates, the ABT might choose to not recommend any bond fund at the current time.

In Step 32, the ABT 11 obtains information on when an investor might need money from an investment account. For example, an investor might have provided information to the IAA that she will need to withdraw significant sums of money starting in two years and 3½ months due to a child starting college.

In Step 33, the ABT 11 selects one or more individual fixed income investments which will mature shortly before the investor needs the money. For the above example, the ABT could select a bond ladder of US treasury securities with maturity dates based on times when the investor will need to pay for college expenses.

For a highly risk-averse investor, bond funds may be too risky, as they can lose money when interest rates rise. For such investors, the ABT can steer them to fixed-income securities whose principal and interest are guaranteed by the US government. The intention would be for these fixed-income securities to be held to maturity. The ABT 11 would get input from such an investor on how long she (or he) anticipates keeping funds invested and when different amounts of money would be wanted (possibly needed) from her portfolio. The ABT 11 could then structure a set of investments in fixed-income securities whose principal and interest are guaranteed by the US government in the form of at least one ladder (such as at least one bond ladder). This means that the maturity of the securities would be staggered to meet at least two objectives. The first objective would be for the investor to have her money in cash when she needs it without having to sell any of the fixed-income securities before maturity to get her money (as selling before maturity could result in a loss or lower return). The second objective would be to allow the ABT to periodically reinvest fixed-income securities which have matured so that the risk of having a large chunk of money invested all at once at a period where interest rates are at a low point is reduced.

It should be noted that ladders of fixed-income securities guaranteed by the US government are not only for extremely risk-averse investors. These investments could be appropriate for less risk-averse investors as well. The less risk averse investor would be expected to have a smaller percentage of her (or his) portfolio invested in such a manner than a highly risk averse investor.

During periods where interest rates are rising, this type of investing strategy may be applicable for a broad set of investors who know in advance how long they can keep a certain sum of money invested before they will need it. The reason is that rising interest rates can hurt the value of bond funds. This is particularly true when the Federal Reserve is aggressively raising interest rates (and possibly reducing its balance sheet) to fight inflation as has been the case in 2022. The laddering strategy described above can alleviate the problem of declining fixed income security values as interest rates rise.

The ABT 11 keeps track of is interest rate trends. When interest rates are rising, it will recommend (and/or invest) less money in bond funds (in some cases, no money at all). When interest rates are steady and not rising, the ABT will often recommend (and/or invest) money in at least one bond fund. When interest rates are falling, the ABT will often recommend (and/or invest) money in at least one long-term bond and/or at least one long-term bond fund, as long-term bonds gain more value when interest rates fall than shorter-duration bonds.

In the specific case when the Federal Reserve is in a cycle of raising the federal funds rate, the ABT will recommend (and/or invest) less money in bond funds (in some cases, no money at all).

In order to assess interest rate trends, the ABT keeps track of monetary policies being followed by central banks of the major economies, such as the US Federal Reserve, the European Central Bank, the Bank of Japan, People's Bank of China, etc. The ABT is aware of interest rates set by these central banks as well as other policies, such as quantitative easing. For example, the US Federal Reserve started tapering its bond purchases in November of 2021, in preparation for ending them altogether, which happened in March of 2022. It then started raising interest rates at the fastest pace in decades. This type of monetary policy results in higher interest rates. The ABT thus may recommend low exposure to bond funds (can be as low as 0 (no exposure)) while the Federal Reserve is significantly raising interest rates (possibly along with other central banks) to try to combat inflation.

When interest rates are not rising by a significant amount, the ABT might recommend (and/or invest in) at least one bond fund, depending upon the risk profile of the investor. There are a wide variety of bond funds to choose from. Investor risk profiles can be used to determine how investments should be distributed across different types of investments. The ABT would typically invest in safer bond funds for more risk-averse investors. For more aggressive investors, the ABT would typically invest in bond funds with a higher potential payoff; these bond funds would typically have a greater risk of losing money, however.

For an investor with an average risk profile, the ABT 11 might invest a significant amount of money in at least one total US investment-grade bond fund like AGG, BND, VBTLX, etc.

For a risk-averse investor who wants some exposure to bond funds, the ABT might invest a significant amount of money in at least one short-term US treasury bond fund like VGSH, SHY, etc. For a higher return with a higher risk of loss (if interest rates rise), the ABT might select an intermediate term US treasury bond fund like VGIT.

If the economy is strong, corporate bond funds may outperform US treasury bonds of similar duration. One drawback is that there is a higher correlation between corporate bonds and the stock market than between US treasury bonds and the stock market. Investment-grade corporate bonds are safer than high-yield (aka junk) corporate bonds. For investors expressing a preference for higher quality corporate bonds, the ABT might select at least one investment-grade corporate bond fund such as VTC, LQD, CORP, etc.

For aggressive investors seeking a higher return who are willing to risk higher losses, the ABT might select at least one high-yield corporate bond fund such as ANGL, FALN, etc.

Municipal bonds would be relevant for investors looking to reduce their taxes, as they are generally not taxable at the federal level. Municipal bonds carry higher risk than US treasury bonds, however. For an investor whose profile suggests an interest in tax-free bonds, the ABT 11 might pick a municipal bond fund such as VTEB, MTBIX, etc.

High-yield municipal bond funds offer the potential for higher returns than investment-grade municipal bond funds but with greater risk of losing money. For aggressive investors seeking a higher return in tax-free bonds who are willing to risk higher losses, the ABT might select at least one high-yield municipal bond fund such as FMHI, MAYHX, etc.

Longer-term bonds (i.e. bonds with longer maturity periods) have the potential to produce higher returns than short-term bonds (i.e. bonds with shorter maturity periods). The risk is that if interest rates rise, long-term bonds can lose more money than short-term bonds. For aggressive investors seeking a higher return who are willing to risk higher losses if interest rates rise, the ABT can select at least one long-term bond fund. For example, the ABT could invest funds in at least on long-term corporate bond fund, such as VCLT, or possibly a long-term US treasury bond fund like TLT.

Bond funds can gain significant value when interest rates fall. Long-term US treasury bonds in particular do well when interest rates are falling. During periods of falling interest rates, the ABT can buy at least one long-term US treasury bond and/or at least one long-term US treasury bond fund. For a US treasury bonds, the greatest alpha when interest rates are falling is achieved by lower coupon bonds with long durations to maturity. Thus, to try to generate high returns when interest rates are falling, the ABT can pick a zero-coupon US treasury bond with the longest possible maturity (the maximum would be 30 years).

The ABT could also pick at least one long-term US treasury bond fund such as ZROZ, a zero-coupon long-term US treasury bond fund with significant alpha when interest rates are falling. TLT, VGLT, and EDV are other long-term US treasury bond funds that the ABT can use for investments.

When the Federal Reserve goes through a period of raising the federal funds rate and the rate hikes come to an end, interest rates (yields) on longer duration bonds tend to decrease and their values increase, even if the Federal Reserve is not cutting interest rates. Thus, a good time to buy longer duration bonds is around the time a cycle of rate hikes to the federal funds rate is coming to a conclusion. When the ABT determines that the Federal Reserve is concluding a cycle of rate hikes to the federal funds rate, it can use this as an indication to purchase bonds, either individually and/or through a fund. For greater alpha, the ABT can pick at least one long-term US treasury bond or bond fund, as described above. Total bond funds like AGG and BND also tend to rise during these time periods as they hold some longer duration bonds. Long-term treasury bond funds like ZROZ, TLT, VGLT, EDV, etc. generally rise more during these time periods than total bond funds, but may be more volatile.

Another type of bond that the ABT uses is inflation-protected bonds. For example, the US offers Treasury Inflation-Protected Securities (TIPS). The ABT can invest in individual TIPS as well as TIPS funds, such as SPIP, TIP, VTIP, LTPZ, etc.

TIPS are particularly attractive to investors during periods of high inflation, such as the 2021-2022 timeframe. However, it should be noted that for 2021 and part of 2022, TIPS did not have positive yields to maturity due to the low federal funds rate and quantitative easing. As interest rates rose in 2022, TIPS started having positive yields to maturity. If an inflation-protected bond has a negative yield to maturity, an investor can still make money based on the principal being adjusted due to inflation. The negative yield to maturity indicates that the TIP is not keeping up with inflation, however. TIPS are obviously more attractive to investors when they have a positive yield to maturity.

In order to determine whether TIPS are worth investing in, the ABT examines inflation, interest rate trends, and how TIPS have been performing relative to other bonds. As mentioned above, TIPS are more desirable when they are trading at positive yields to maturity. When at least some TIPS are trading at positive yields to maturity, the ABT makes this information available to investors. This presents an opportunity for investors to protect money from inflation. For examples, on Aug. 29, 2022, US TIPS on the secondary bond market were offering positive yields to maturity across the entire duration of maturities, from the earliest maturity date of Jan. 15, 2023 to the latest maturity date of Feb. 15, 2052. Suppose an investor's profile indicates that she is interested in protecting some money from inflation, and that it will not be wanted (possibly needed) until May of 2029. The ABT could then pick the US inflation-protected bond with CUSIP 912810FH6 which matures on Apr. 15, 2029 for the investment.

Thus, when an investor expresses interest in protecting money from inflation and she has a timeframe for how long the money can remain invested before she needs it, the ABT can try to find an inflation-protected bond with a positive yield to maturity and a maturity date shortly before the investor needs the money. If the ABT cannot find an inflation-protected bond with a positive yield to maturity and a maturity date shortly before the investor needs it, it could then invest the money in an inflation-protected bond with a positive yield to maturity which has the latest maturity date before the investor needs the money. If it turns out that all inflation-protected bonds available for purchase with maturity dates before the investor needs the money have negative yields to maturity, the ABT might choose not to invest money in a specific inflation-protected bond at the current time.

Currently, each TIPS bond offered by the US government has a different maturity date. However, there are other inflation-protected bonds besides US government TIPS. Furthermore, it is possible that the US government could offer different TIPS bonds with a same maturity date at some point in the future; the US government offers different conventional bonds with a same maturity date. Therefore, the ABT allows for the possibility that multiple inflation-protected bonds may have a same maturity date; its bond selection algorithms can handle this situation.

Suppose that there are multiple inflation-protected bonds with positive yields to maturity which mature before the investor needs the money. Let S be the set of all such bonds. Let m1 be a latest maturity date for any bond in S. Let b12 be a bond in S with a highest yield among all bonds in S with a maturity date of m1. The ABT would consider investing in bond b12. If there is a bond b2 in S with a maturity date before m1, the ABT would typically choose to invest money in b12 instead of b2 unless b2 has a higher yield than b12. If b2 has a higher yield than b12, then the ABT could consider both b12 and b2 as candidates for investing money in. The ABT can consider both yields and maturity dates in making investment choices. Higher yields are preferable. In addition, longer duration bonds in S are preferable; such bonds have maturities closer to when the investor needs her money. Thus, the ABT searches for bonds in S with high yields, but also prefers longer duration bonds in S.

The ABT 11 can also invest in at least one bond fund comprised of TIPS including TIP, SPIP, VTIP, LTPZ, etc. One of the problems which we mentioned earlier is that with bond funds, the value is affected by interest rates. If interest rates rise, the value drops. This means that even if the underlying bonds owned by a TIPS bond fund have a positive yield to maturity, the bond fund is not guaranteed to completely protect against inflation as interest rates may rise, reducing the value of the bond fund. Thus, while TIPS bond funds can provide some protection against inflation, the protection will be lessened if interest rates rise sufficiently.

When determining whether to invest in TIPS or conventional bonds, the ABT considers various factors including inflation, interest rate trends, and how TIPS have been performing relative to other bonds. One of the factors is inflation. When an inflation rate exceeds a threshold, the ABT may choose to invest in at least one inflation-protected bond and/or TIPS bond fund; it may also start preferring TIPS over at least one other type of bond while inflation remains elevated. There are multiple methods which are commonly used to measure inflation rates, including Consumer Price Index for All Urban Consumers both seasonally adjusted (CPIAUCSL) and not seasonally adjusted (CPIAUCNS), Personal Consumption Expenditures Seasonally adjusted (PCEPI), versions of these metrics excluding food and energy, etc. The ABT can use these methods for measuring inflation, as well as several others. One method the ABT prefers for measuring inflation rates in regards to TIPS is Consumer Price Index for All Urban Consumers not seasonally adjusted (CPIAUCNS), as that is the metric which is used to adjust the principal of TIPS to protect them from inflation.

When inflation rises, triggering the ABT to invest in TIPS, the ABT may invest in at least one TIPS bond fund. SPIP and TIP are examples of TIPS bond funds. In order to generate higher alpha, the ABT can also invest in long-term TIPS bond funds like LTPZ and DRXIX. LTPZ and DRXIX will do particularly well if interest rates fall. If interest rates rise, however, they can underperform.

When an inflation rate decreases and falls below a threshold, the ABT may choose to sell at least one inflation-protected bond and/or TIPS bond fund; it may also start preferring at least one other type of bond over TIPS while inflation remains reduced.

The ABT also looks at breakeven inflation rates. As an example, the 5-year breakeven inflation rate is the difference between the interest rate on a 5-year treasury bond and a 5-year TIPS bond. Breakeven inflation rates can be calculated for each duration corresponding to the maturity date of an existing TIPS bond. When the breakeven inflation rate for a time period (e.g. 5 years) is below the inflation rate that the IAA believes is plausible for that time period, then the ABT may choose to invest money in a TIPS bond maturing at the end of the time period. When the breakeven inflation rate for a time period (e.g. 5 years) is above the inflation rate that the IAA believes is plausible for that time period, then the ABT may choose not to invest money in a TIPS bond maturing at the end of the time period.

As another example of how the ABT can pick bonds to invest in, when the breakeven inflation rate for a time period (e.g. 5 years) is below the inflation rate that the IAA believes is plausible for that time period by at least a threshold t1, then the ABT may choose to invest money in a TIPS bond maturing at the end of the time period. When the breakeven inflation rate for a time period (e.g. 5 years) is above the inflation rate that the IAA believes is plausible for that time period by at least a threshold t2 (t2 might equal t1; alternatively, t2 may differ from t1), then the ABT may choose not to invest money in a TIPS bond maturing at the end of the time period.

The ABT can be configured to use breakeven rates to choose between TIPS and US conventional treasury securities. If the breakeven rate for a TIPS bond b1 which matures in m1 years exceeds the inflation rate that the IAA estimates will occur over the next m1 years, then the ABT favors investing in a conventional treasury security. Otherwise, the ABT favors investing in b1.

While the example above uses a period of 5 years, the ABT considers breakeven rates across the full range of TIPS maturity dates, including durations both longer and shorter than 5 years. Shorter durations have an advantage that the money does not need to be tied up for a long period of time. Longer durations have an advantage that a good yield can be locked in for a longer period of time.

As a TIPS bond approaches maturity, there is often considerable volatility in its yield. This can present a good opportunity to obtain a favorable yield if the yield spikes to a high level. The ABT can take advantage of this by buying the TIPS bond and obtaining a high yield for the relatively short period remaining before the bond matures. It should be noted that the TIP yield can also drop considerably before maturity to a significantly negative yield. The ABT would avoid purchasing such a bond when its yield has dropped to too low a level.

Trading individual bonds can incur transaction costs, as bid-ask spreads can be significant. The ABT is aware of bid-ask spreads and factors it into its decisions on which bonds to buy. In order to minimize transaction costs, the ABT will typically buy bonds when information from the investor indicates that there is a high probability that the bond can be held to maturity. While there is a transaction cost for buying the bond, in most cases, the bond will not be sold before maturity, so there will not be transaction costs for selling the bond.

The IAA considers bid-ask spreads in making investment decisions for a wide variety of securities, including stocks and bonds (both individual stocks/bonds as well as funds). If the bid-ask spread is significant, it can affect trading decisions. Individual bonds can have significant bid-ask spread differences, which can affect trading decisions. US treasury bonds tend to have narrower spreads than most other types of bonds. However, TIPS tend to have larger spreads than conventional treasury bonds, particularly longer duration TIPS. If a security, such as an individual bond, has a bid ask spread which is too wide (for example, if the bid-ask spread exceeds a threshold), the IAA may be less inclined to purchase the security.

In some cases, the IAA might have a choice of purchasing two different securities, a1 and a2, with similar expected performance. If a1 has a smaller bid-ask spread, the IAA might select a1 over a2. In general, the IAA might consider bid-ask spreads, along with other criteria, in determining which security (s) to purchase.

In some cases, the ABT determines that a bond fund might do a better job of masking bid-ask spreads than individual bonds. In that case, the ABT might favor the purchase of the bond fund over at least one individual bond.

For example, suppose that the ABT is considering purchasing at least one inflation-protected bond in response to an elevated CPI. The ABT might determine that an inflation-protected bond fund is better at alleviating the impact of bid-ask spreads than the bid ask spreads the ABT is likely to encounter in purchasing at least one individual inflation-protected bond. This determination could be a factor which would cause the ABT to favor purchasing the inflation-protected bond fund over purchasing at least one individual inflation-protected bond.

### Agile Investment Manager (AIM)

An issue in investing is how to invest in a security which has high potential for returns but is volatile and can also lose money as well. The IAA has a module known as the Agile Investment Manager (AIM) 12 which can invest in risky securities while limiting losses. The AIM is appropriate for securities with both high alpha and high beta. For example, a security may have high alpha if its alpha exceeds a threshold ta1. A security may have high beta if its beta exceeds a threshold tb1. The AIM 12 can actually be used for a wide variety of securities, including those which are not particularly risky. Some scenarios in which the AIM would be particularly useful include, but are not limited to, the following:
Leveraged stock funds, such as UPRO, SPXL, TQQQ, TECL, SOXL, etc.
Individual stocks, particularly volatile stocks with the potential for high returns
Commodity funds, including leveraged commodity funds
Long-term bonds and/or bond funds
Suppose an investor has a default stock allocation, e.g. 60%. She wants to get more alpha than a 60% allocation to stocks. However, she does not want to incur the volatility and risk that a higher allocation to stocks would typically incur. In that case, the IAA would invest 60% of the portfolio in equities using some of the methods described above. It could then take an additional amount (e.g. 10%, for example) of the investment account and put it in equities (e.g. in an index fund like VOO and/or VTI, for example) managed by the AIM. This additional amount would be conservatively managed by the AIM so that it would provide some of the returns of the stock market while limiting losses. The investor would thus get some additional performance beyond 60% allocation in stocks while not incurring the full risks that a higher allocation to stocks would incur.

We now explain how the AIM 12 would work for managing the S&P 500 leveraged ETF UPRO. AIM can manage other types of investments in a similar manner. The AIM evaluates market conditions to determine if it is favorable to invest in UPRO. We previously described several techniques for making this determination. We now give more specific examples. For much of the period from Mar. 23, 2020-Nov. 8, 2021, the AIM would have concluded that conditions were favorable for investing in UPRO. The stock market was soaring, and the Federal Reserve was providing considerable support for financial markets with low interest rates and quantitative easing. For much of 2022 through September, the AIM would have concluded that conditions were not favorable for investing in UPRO. The stock market performed poorly, the Federal Reserve was pursuing hawkish policies to try to bring inflation under control, and the economy was slowing.

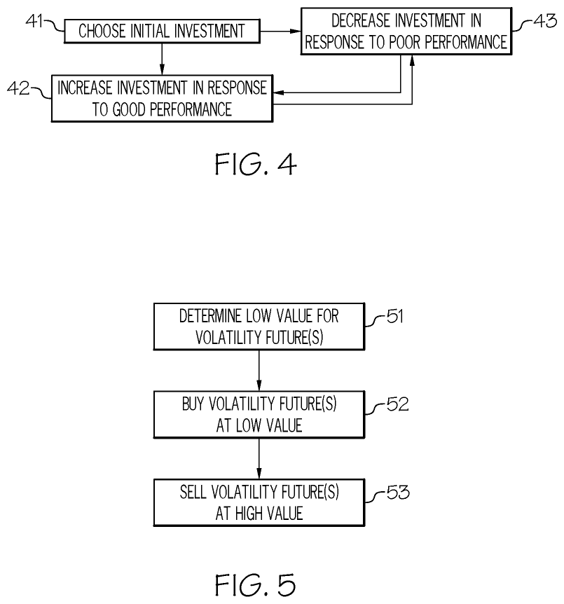

When the AIM determines that conditions are favorable for investing in UPRO, it invests a certain amount of money in UPRO based on a parameter, initial_amount (FIG. 4, Step 41). The AIM 12 has multiple methods for evaluating the performance of UPRO. One method is based on the returns of the UPRO investment. The performance rises when the UPRO investment produces a positive return. The performance falls when the UPRO investment produces a negative return. This is a straightforward performance metric. Another performance metric would be the returns of the UPRO investment relative to an index or another investment, such as the VTI total market fund. If the AIM 12 is comparing UPRO to VTI, then the performance of UPRO would increase when it outperforms VTI. The performance of UPRO would decrease when it underperforms VTI.

If the AIM determines that the market conditions for UPRO have become unfavorable, it can sell at least some of the UPRO investment. If a recent performance of UPRO falls below a threshold (e.g. UPRO has lost over 15% in the last 10 trading days, for example), the AIM can also sell at least some of the UPRO investment (FIG. 4, Step 43). In order to limit a total loss, the AIM can maintain a second threshold, maximum_loss. When the total loss for UPRO (as determined by the performance metric) exceeds maximum_loss, the AIM can sell all shares of UPRO.

If the AIM sells at least some of the UPRO investment, it might buy more UPRO if it determines at a subsequent point in time that market conditions have become favorable for investing in UPRO.

If the AIM 12 has invested money in UPRO and UPRO has been producing positive returns that exceed a threshold based on a performance metric p1 that the AIM is using (e.g. UPRO has gained 15% more than the S&P 500 ETF VOO since a last time the AIM invested additional money in UPRO, not including reinvested UPRO dividends), the AIM can invest more money in UPRO, gradually increasing exposure to UPRO as UPRO continues to gain as measured by p1 (FIG. 4, Step 42). The rate at which the AIM buys additional shares of UPRO in response to good performance from UPRO can be based on an aggressiveness parameter a1 and/or a percentage of the portfolio invested in UPRO. A higher value of a1 means that the AIM will buy shares at a higher rate in response to good performance from UPRO. This can result in better returns if UPRO continues to gain. On the other hand, it can result in poorer returns if UPRO starts to drop (as measured by p1).

If UPRO only constitutes a small percentage of the portfolio, then the AIM 12 can buy more shares of UPRO in response to good performance. If UPRO constitutes a significant percentage of a portfolio, then the AIM might not buy more shares of UPRO in response to good performance.

For example, if UPRO comprises less than t5 percent of a portfolio for a threshold t5, then the AIM might buy more shares in response to good performance from UPRO. Once UPRO comprises at least t5 percent of the portfolio, then the AIM might not buy more shares of UPRO, even though UPRO is performing well. This approach limits exposure to UPRO, as having too high an allocation to UPRO incurs risk.

If an allocation of UPRO in the portfolio exceeds a threshold t6 (t5 might equal t6; alternatively, t5 may differ from t6), then the IAA can perform portfolio rebalancing in which shares of UPRO are sold to reduce exposure to UPRO. The IAA can perform portfolio rebalancing for other securities in a portfolio as well, whether or not they are risky securities being managed by the AIM.

### Investing in Volatility Futures and Options

Volatility refers to the frequency and magnitude of changes that a quantity, such as a stock market index, experiences over a period of time. Larger changes are associated with higher volatility. Volatility indices such as the CBOE volatility index (VIX) were described and explained earlier. The VIX is commonly used as a measure of a volatility of the S&P 500 stock market index. The IAA can purchase futures and options based on predicted future values of a volatility index such as the VIX. We refer to such futures and options as volatility futures and volatility options, respectively. Funds such as VIXY and VIXM hold volatility futures. Volatility futures and options can be used to hedge against declines in the stock market. The values of volatility futures are typically negatively correlated with stock market returns. When the stock market is declining, the volatility futures tend to rise in value. When the stock market is rising, the volatility futures tend to decline in value.

The IAA allows investors to invest in volatility futures either by directly purchasing volatility futures and/or by investing in funds which hold volatility futures, such as VIXY and VIXM, which are ETFs, as well as VXX and VXZ which are ETNs, as well as other volatility futures funds and/or ETNs. We refer to funds which hold volatility futures as volatility futures funds. We refer to ETNs which hold volatility futures as volatility futures ETNs. VIXY and VIXM are examples of volatility futures funds. VXX, and VXZ are examples of volatility futures ETNs. The IAA would typically purchase volatility futures after a period when the stock market has done well and the volatility futures are trading at a depressed level. If the stock market starts dropping, the volatility futures could rise. The IAA tracks the performance of the overall stock market and the volatility futures. The IAA would hold onto the volatility futures while the stock market continues to drop and the volatility futures continue to rise. Once the stock market stops declining, the volatility futures would likely stop rising. When the stock market stops declining and/or the volatility futures stop increasing and the IAA has insufficient information to indicate a high probability of the stock market resuming declining and/or volatility futures resuming increasing, the IAA might sell at least some shares of the volatility futures.

If a volatility future purchased by the IAA shows sufficient gain (for example, its increase in value exceeds a threshold), then the IAA may sell the future, even before the volatility future starts decreasing. This will lock in a profit for the investor.

When the stock market is not declining, volatility futures may decrease in value. Some of this may be due to contango. If the IAA has purchased at least one volatility future and the at least one volatility future is losing value, possibly due to contango, the IAA might sell part or all of the at least one volatility future to limit losses.

Certain types of volatility futures are less subject to losses due to contango than others. For example, longer term volatility futures may be less subject to contango than shorter term volatility futures. The longer duration volatility futures may be more appropriate to hold for a longer period of time without incurring the losses of shorter duration futures. However, shorter duration volatility futures can provide more gains during volatile periods typically associated with stock market declines.

The IAA thus invests in volatility futures in a variety of ways. For the highest potential gains but the greatest risk, it can invest in leveraged volatility futures. For example, UVIX is a leveraged VIX futures ETF which can have substantial gains when volatility increases. However, it can incur substantial losses when volatility decreases.

For incurring less risk than leveraged volatility futures, the IAA can invest in unleveraged short-term volatility futures, either by purchasing the futures directly and/or using a fund such as VIXY and/or VXX (VXX is an ETN) which both hold VIX short-term futures.

For incurring less risk and an investment with the potential to be held longer without incurring substantial losses, the IAA can invest in longer term volatility futures, either by purchasing the futures directly and/or using a fund such as VIXM and/or VXZ (VXZ is an ETN) which both hold VIX mid-term futures.

The IAA can also purchase a combination of leveraged and unleveraged volatility futures of differing durations to diversify its volatility holdings.

The following approach can be used for investing in volatility futures. It is particularly applicable to, but not limited to, volatility futures which do not decrease in value significantly over time due to contango, including VIX mid-term futures purchased individually as well as VIX mid-term futures funds and/or ETNs such as VIXM and VXZ. Let v1 be (1) at least one volatility futures fund and/or ETN such as VIXM or VXZ; and/or (2) at least one volatility future. A baseline price p1 is established based on past history of v1 (FIG. 5, Step 51). The baseline price represents a level which is typical when the stock market has recently performed well (for example, the stock market (e.g. a stock market index, such as the S&P 500) has gone up in value over a sustained time interval) and the volatility level is low. Ideally, the baseline price should be determined by looking at several past periods when the stock market has gone up in value over a sustained time interval. The baseline price would be determined based on recent low prices of the volatility futures over a time period ranging from several months to a year, for example.

After a period during which the stock market has performed well and the price of v1 is either less than or equal to p1 or only exceeds p1 by a threshold, the IAA invests in v1 (FIG. 5, Step 52). The IAA might make the investment when the price of v1 is low, before the price of v1 starts increasing. Alternatively, the IAA might wait for the price of v1 to increase a bit before investing in it.

If the price of v1 rises, indicating higher volatility, this would usually be correlated with a decline in the stock market. At some point after the price of v1 rises, the IAA would sell at least some of v1 (FIG. 5, Step 53). The IAA could sell at least some of v1 after the price of v1 stops rising (which would likely correlate with the stock market decline coming to an end) and/or the IAA determining that v1 is unlikely to rise much further in the near future (which would likely mean that the stock market is unlikely to significantly decline much in the near future). The IAA could also sell at least some of v1 in response to an increase in the price of v1 exceeding a threshold.

The IAA can effectively trade a wide variety of types of volatility futures including CBOE VIX futures and other types of volatility futures.

Volatility options can be used in a similar way as volatility futures described above.

### Non-Limiting Examples

As will be appreciated by one of ordinary skill in the art, in view of the discussions herein, aspects of the present invention may be embodied as a system, method, or computer program product. The computer program product may include a computer readable storage medium (or media) having computer readable program instructions thereon for causing a processor to carry out aspects of the present invention.

Accordingly, one or more aspects of the present invention may take the form of an entire hardware embodiment, an entire software embodiment (including firmware, resident software, micro-code, etc.), or an embodiment combining software and hardware aspects that may all generally be referred to herein as a “circuit”, “module”, or “system”. Furthermore, parts of the present invention may take the form of a computer program product embodied in one or more computer-readable medium(s) having the computer-readable program code embodied thereon.

An Intelligent Asset Allocator (IAA) 10 may utilize any combination of computer-readable medium(s). The computer-readable medium may be a computer-readable signal medium or a computer-readable storage medium. A computer-readable storage medium is a tangible medium which may be, for example, but not limited to, an electronic, magnetic, optical, electromagnetic, infrared, or semiconductor system, apparatus, or device, or any suitable combination of the preceding.

More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the preceding. In the context of this document, a computer-readable storage medium may be any tangible medium that can contain or store a program for use by or in connection with an instruction execution system, apparatus, or device.

A computer-readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium, and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the preceding.

Computer program code for carrying out operations for aspects of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Java, Smalltalk, C++, or the like, and conventional procedural programming languages, such as the “C” programming language or similar programming languages. According to various embodiments of the invention, the program code may execute entirely on a user's computer, partly on a user's computer, as a stand-alone software package, partly on a user's computer and partly on a remote computer or entirely on a remote computer or a server. In the latter scenario, the remote computer or the server may be connected to the user's computer through any type of network, including one or more of a local area network (LAN), a wireless communication network, a wide area network (WAN), or a connection may be made to an external computer (for example, through the Internet using an Internet Service Provider).

Aspects of the present invention have been discussed above with reference to flow diagram illustrations and/or block diagrams of methods, apparatus (systems), and computer program products according to various embodiments of the invention. It will be understood that each block of the flow diagram illustrations and/or block diagrams and combinations of blocks in the flow diagram illustrations and block diagrams can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks. In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

These computer program instructions may also be stored in a computer-readable medium that can direct a computer, other programmable data processing apparatus, or other devices, to function in a particular manner, such that the instructions stored in the computer-readable medium produce an article of manufacture including instructions which implement the function/act specified in the flow diagram and/or block diagram block or blocks.

The computer program instructions may also be loaded onto a computer, other programmable data processing apparatus, or other devices, to cause operational steps to be performed on the computer, other programmable apparatus, or other devices, to produce a computer-implemented process (or method) such that the computer instructions which execute on the computer or other programmable apparatus provide processes for implementing the functions/acts specified in the flow diagram and/or block diagram block or blocks.

The terminology used herein is to describe particular embodiments only and is not intended to be limiting of the invention.

As used herein, the singular forms “a”, “an”, and “the”, are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “a” or “an,” as used herein, are defined as one or more than one. The term “plurality”, as used herein, is defined as two or more than two. The term “multiplicity”, as used herein, is defined as a large number which can be at least ten. The term another, as used herein, is defined as at least a second or more. The terms “comprises” and/or “comprising”, when used in this specification, specify the presence of stated features, steps, operations, elements, and/or components but do not preclude the presence or addition of one or more other features, steps, operations, elements, components, and/or groups thereof. The terms “including” and “having”, as used herein, are defined as comprising (i.e., open language). The term “coupled”, as used herein, is defined as “connected,” although not necessarily directly and not necessarily mechanically. The term “communicatively coupled” refers to coupling of components such that these components are able to communicate with one another through, for example, wired, wireless, or other communications media. The terms “communicatively coupled” or “communicatively coupling” include, but are not limited to, communicating electronic control signals by which one element may direct or control another.

The term “configured to” describes the hardware, software, or a combination of hardware and software that is adapted to, set up, arranged, built, composed, constructed, designed, or that has any combination of these characteristics to carry out a given function. The term “adapted to” describes the hardware, software, or a combination of hardware and software capable of performing, able to accommodate the performance of, that is suitable to perform, or that has any combination of the characteristics mentioned above to perform a given function. The terms “including” and “having,” as used herein, are defined as comprising (i.e., open language).

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted herein by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed. The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The description of the invention has been presented for purposes of illustration and description but is not intended to be exhaustive or limited to the invention in the form disclosed. Many modifications and variations will be apparent to those of ordinary skill in the art without departing from the scope of the invention. Each embodiment was chosen and described in order to best explain the principles of the invention and the practical application and to enable others of ordinary skill in the art to understand the invention for various embodiments with various modifications as are suited to the particular use contemplated.

What is claimed is:

1. A computer-implemented method for automatically managing a plurality of investment accounts comprising the steps of:
maintaining a data store including account information associated with the plurality of investment accounts;
monitoring and analyzing prices of one or more securities;
determining a plurality of past time periods wherein each past time period in the plurality of past time periods is associated with at least one characteristic which can increase or decrease a value of at least one of the one or more securities, comprising the steps of:
selecting a plurality of stock sectors;
determining a relative performance of one or more pairs of stock sectors in the plurality of stock sectors at multiple points in time, and
in response to a sum of changes in relative performances of the one or more pairs of stock sectors in the plurality of stock sectors determined for a time t1 exceeding a threshold, specifying t1 as a starting point or an ending point of a past time period;
determining at least one characteristic cl which can increase or decrease a value of at least one of the one or more securities corresponding to a current time period;
determining a subset s1 of the plurality of past time periods wherein each time period in s1 is associated with cl;
analyzing performance for several securities during the time periods which are members of s1; and
selecting at least one security for at least one investment account in the plurality of investment accounts, wherein for each security i1 of the at least one security, a return over the time periods in s1 after an inception of i1 exceeds a return for a market index over the time periods in s1 after the inception of i1.

2. The method of claim 1, wherein the at least one characteristic which can increase or decrease a value of at least one of the one or more securities comprises at least one of a rising stock market index, a falling stock market index, a rising interest rate for at least one US treasury bond, a falling interest rate for at least one US treasury bond, quantitative easing, quantitative tightening, a change in monetary policy, a recession, and inflation.

3. The method of claim 1, further comprising executing at least one transaction to invest in at least one semiconductor stock during a period when a US Federal Reserve is lowering a federal funds rate.

4. The method of claim 1, further comprising:
in response to determining that a stock market index is declining, executing at least one transaction to reduce a percentage of the at least one investment account allocated to stocks and executing at least one transaction to invest in at least one defensive stock wherein the at least one defensive stock is in one or more stock sectors selected from utility, consumer staples, and health care.

5. The method of claim 4, further comprising:
determining a high volatility threshold for a volatility index based on recent peak levels of the volatility index; and
in response to the volatility index declining after exceeding the high volatility threshold and a stock market index ceasing to decline, executing at least one transaction to buy at least one stock.

6. The method of claim 5, in which the volatility index comprises a CBOE volatility index.

7. The method of claim 1, further comprising in response to determining that interest rates for at least one US treasury bond are rising, value stocks are rising, and growth stocks are falling, executing at least one transaction to sell at least one growth stock and buy at least one value stock.

8. The method of claim 1, further comprising:
executing at least one transaction to invest an initial amount of money in a security;
in response to a performance of the security exceeding a threshold, executing at least one transaction to purchase an additional quantity of the security;
in response to the performance of the security falling below a second threshold, executing at least one transaction to sell a quantity of the security; and
in response to the performance of the security falling below a third threshold, executing at least one transaction to sell all of the security.

9. The method of claim 1, further comprising selecting a volatility futures fund or volatility futures ETN f1;
determining a baseline price for f1 based on recent periods when a stock market index has increased;
executing at least one transaction to purchase shares of f1 when a price of f1 is less than or equal to the baseline price plus a threshold;
in response to the price of f1 increasing, executing at least one transaction to sell shares of f1 after the price of f1 starts to decrease; and
in response to the price of f1 exceeding a second threshold, executing at least one transaction to sell shares of f1.

10. The method of claim 1, further comprising creating a plurality of predictive models for each of a plurality of securities, wherein the plurality of predictive models infer future performance based on performance over past periods using neural networks and regression models wherein covariates for the regression models include performance of market indices and performance of sector funds;
selecting a best model for each security which predicts performance of the security with a minimum error; and
selecting a security whose best model results in a highest performance.

11. A computer-implemented method for automatically managing a plurality of investment accounts comprising the steps of:
maintaining a data store including information on the plurality of investment accounts;
monitoring and analyzing prices of one or more securities;
determining a plurality of past time periods wherein each past time period in the plurality of past time periods is associated with at least one characteristic known to have an effect on prices of securities;
determining at least one characteristic cl known to have an effect on prices of securities corresponding to a current time period;
determining a subset s1 of the plurality of past time periods wherein each time period in s1 is associated with cl;
analyzing performance for several securities during time periods which are members of s1, comprising the steps of:
assigning similarity scores based on a plurality of characteristics selected from a federal funds rate, US treasury yields of different durations, interest rate trends, inflation rates, inflation trends, oil prices, and oil price trends, wherein each similarity score is positively correlated with how similar the characteristic is in the current time period and a past time period;
assigning an additional similarity score for the current time period and the past time period based on a relative performance of defensive sectors to an overall stock market;
computing aggregate similarity scores for each past time period in s1 from at least one similarity score associated with the past time period; and
determining performance of a security over a plurality of past time periods in s1 by weighting returns in each of the plurality of past time periods in s1 by an aggregate similarity score for the past time period; and
selecting at least one security for at least one investment account in the plurality of investment accounts wherein for each security i1 of the at least one security, a return over at least one time period in s1 after an inception of i1 exceeds a return for a market index over the at least one time period s1 after the inception of i1.

12. A system for managing investments for a plurality of users comprising:
a user interface communicatively coupled via a network to at least one processor configured to execute computer program instructions, wherein the at least one processor, responsive to executing computer program instructions, performs a method comprising:
storing, in at least one data store, information about users, accounts, and investments;
analyzing data on past returns of securities and financial market conditions to select securities, wherein said data includes interest rates on at least one US treasury bond;
receiving data from a plurality of users via the user interface, wherein for each user in the plurality of users said data includes an amount of money wanted and a date by which the money is wanted; and
executing at least one transaction, by communicating at least one transaction message via a computer network interface communicatively coupled with the at least one processor, the at least one transaction being executed to purchase, for a user in the plurality of users, at least one fixed rate security with a maturity date based on the date provided by the receiving data via the user interface;
executing at least one transaction to purchase at least one fixed rate security for the user in response to the analyzing data indicating a rising interest rate for at least one US treasury bond;
executing at least one transaction to purchase at least one long-term bond or at least one long-term bond fund for the user in response to the analyzing data indicating a falling interest rate for at least one US treasury bond;
executing at least one transaction to purchase at least one fixed rate security for the user in response to determining a low risk tolerance level for the user; and
executing at least one transaction to purchase at least one high-yield bond or at least one high-yield bond fund for the user in response to determining a high risk tolerance level for the user.

13. The system of claim 12, wherein the at least one processor, responsive to executing computer program instructions, performs a method comprising:
maintaining information on at least one inflation rate; and
executing at least one transaction to purchase at least one inflation-protected bond or at least one inflation-protected bond fund in response to the inflation rate exceeding a threshold.

14. The system of claim 13, wherein the at least one processor, responsive to executing computer program instructions, performs a method comprising:
executing at least one transaction to sell at least one inflation-protected bond or at least one inflation-protected bond fund in response to the inflation rate falling below a threshold.

15. The system of claim 12, wherein the at least one data store comprises a relational database management system or a NoSQL store.

16. The system of claim 12, wherein the at least one processor, responsive to executing computer program instructions, performs a method comprising:
analyzing information on current financial market conditions and current returns of different types of securities; and
choosing at least one security based on a performance of the security in past time periods having at least one currently existing financial market condition.

17. The system of claim 16, in which said current financial market conditions include at least one of a federal funds rate, yields for US treasury bonds of different maturities, an inflation rate, a monetary policy authorized by a US Federal Reserve, GDP, and an unemployment rate.

18. The system of claim 12, wherein the at least one processor, responsive to executing computer program instructions, performs a method comprising:
executing at least one transaction to reduce a percentage of at least one investment account allocated to stocks and executing at least one transaction to invest in a plurality of defensive stocks, wherein the plurality of defensive stocks are in one or more stock sectors selected from utility, consumer staples, and health care, in response to determining that a stock market index is declining.

19. The system of claim 12, wherein the at least one processor, responsive to executing computer program instructions, performs a method comprising:
executing at least one transaction to invest in at least one growth stock, in response to determining that an interest rate for at least one US treasury bond is not increasing by an amount exceeding a threshold.

20. The system of claim 12, wherein the at least one processor, responsive to executing computer program instructions, performs a method comprising:
executing at least one transaction to invest in at least one energy stock, stock fund, or oil futures fund, in response to rising energy commodity prices; and
executing at least one transaction to sell at least one energy stock, stock fund, or oil futures fund, in response to falling energy commodity prices.
